(19) United States
(12) Patent Application Publication
(10) Pub. No.: US 2020/0334765 A1
(43) Pub. Date: Oct. 22, 2020

(54) METHOD AND APPARATUS FOR FACILITATING FACE-TO-FACE COMMUNICATION AND FACE-TO-FACE NETWORKING

(71) Applicant: Daniel NORRIS, London (GB)

(72) Inventor: Daniel NORRIS, London (GB)

(21) Appl. No.: 16/853,105

(22) Filed: Apr. 20, 2020

Related U.S. Application Data
(60) Provisional application No. 62/910,518, filed on Oct. 4, 2019.
(60) Provisional application No. 62/836,096, filed on Apr. 19, 2019.

(51) Int. Cl. G06Q 50/00; G06Q 20/08; G09B 19/00; G01C 21/20; H04W 4/029; H04N 9/31

(52) U.S. Cl. CPC G06Q 50/01; G06Q 20/085; G09B 19/00; G06Q 30/0201; H04W 4/029; H04N 9/3141; G01C 21/20

(57) ABSTRACT

A communications system and method structures and coordinates face-to-face communication and face-to-face networking, providing new functionality, a better user experience, new commercial uses and new business methods for its monetization. Pathway versions of the system and method are a more dynamic variant, structuring user conversations as they move from one location to another, while tracking the mutation of discussion topics from one subject to another. A configurable version of the system and method enables it to be built in any business place, customized and configured to that specific location. New features of the system and method now combine face-to-face communication with online communication in ways that were not previously possible.

This application claims priority from provisional application nos. 62/836,096 filed on Apr. 19, 2019 and 62/910,518 filed on Oct. 4, 2019, both of which are incorporated in their entirety herein

### FIELD OF THE INVENTION

The invention relates to improvements in method and apparatus for facilitating face-to-face communication and face-to-face networking, and particularly improvements in terms of monitoring the progression of the communications and networking, allowing more interaction for users in determining what types of communications and networking would occur, new commercial uses and methods of monetisation, improvements directing users to find different subjects and discussions in a given place, and use of the internet, mobile devices, and smartphones to enhance a user's experience, combining face-to-face communication with online communication in ways that were not previously possible.

### BACKGROUND ART

The use of a communications system and method to facilitate face-to-face discussions is disclosed in U.S. Pat. No. 7,111,244. FIGS. 1-3 of this patent are shown to provide a base understanding of the platform of this patent. FIG. 1 shows a table 1 which accommodates users and an electronic sign-board 2 which is used to display subjects for discussion. In some embodiments of the invention the electronic sign-board 2 can be altered remotely by a microcomputer. In some embodiments the electronic sign-board 2 can be operated locally by a keyboard 3. In some embodiments the electronic sign-board 2 can be operated both locally and remotely.

FIG. 2 shows a plan view of a possible embodiment in which users are accommodated at loosely tessellated hexagonal tables. (this is not a scale diagram and spaces between tables would be greater than the appearance of the diagram suggests). FIG. 2 shows hexagonal tables 1 that are grouped into colored zones in which users discuss similar subjects. Zones are identified by large electronic signboards 4. Surfaces of tables in the same zone are lit in the same color. A table adjacent to a zone may therefore be added to a zone by illuminating its surface in the color that codes for that zone.

FIG. 3 is a view of a display unit. Electronic discussion topic sign-boards communicate with the display unit FIG. 3, which provides an overview of the whole facility and shows what is being discussed at each table as well as displaying the names and colors of topic zones.

### SUMMARY OF THE INVENTION

The invention is an improvement in a communication system that includes an array of spaced apart locations at each of which a plurality of users may enter into discussion with one another in person, discussion signs for displaying subjects for discussion, wherein each discussion sign is associated with a location, whereby the discussion signs are able to display subjects for discussion at the location associated with each location, subject zone signs, each subject zone sign associated with a number of spaced apart locations and configured for displaying a subject that is common to the discussions at the spaced apart locations, a main display that provides an overview that shows a physical location of the subject zone signs and discussion signs associated with a subject zone sign, and control means for operating at least said discussion signs so as to enable said discussion signs to display subjects for discussion wherein said control means can amend the information displayed by said discussion signs so as to enable said discussion signs to display new subjects for discussion.

The invention is also an improvement in a method of communication that facilitates face-to-face discussion by (i) providing an array of spaced apart locations at each of which a plurality of users may enter into discussion with one another, (ii) providing each location with indicia associated with a subject for discussion, (iii) displaying discussion topics by said indicia at said spaced apart locations, enabling users to gather together at said spaced apart locations to form groups to pursue the discussion indicated by said indicia, (iv) displaying a new discussion topic by at least one of said indicia at said spaced apart locations to set up a new discussion group, (v) providing either a remote control or a local control to alter said indicia at at least one of said spaced apart locations to display new discussion topics to set up a new discussion group at said location, and controlling said indicia at at least one of said spaced apart locations by said remote or local control whereby users may participate in person in a structured networked discussion.

While certain features of the invention are provided to enhance the communication system, such features are also applicable to the communication method described above.

In one aspect of the invention improves the users experience by providing the user with one or more indications of how the discussions are progressing so that a user can possibly move and engage in a different discussion. In this regard, progression indicia are provided that associated with either a discussion sign, a subject zone sign, or one of the locations, the progression indicia indicating that a subject and/or a common subject is moving from one location to another so one or more users can migrate to a different location for discussion.

The progression indicia can be displayed on a subject zone sign or discussion sign or other structure positioned between the location and the different location. An example of a progression indicia, an arrow or other directional signal, illuminated or non-illuminated. Other structures can include a walking surface between locations or an elevated surface, preferably a ceiling between locations.

The control means or controller can be configured to track one or more users' movements between locations using a mobile device of the user and a link between the mobile device and the control means. The control means can be configured to track the change of location of subjects and common subjects.

The progression indicia can display changes that have occurred for subjects or common subjects so that a user can see how the subjects or common subjects have mutated.

Another aspect of the invention improves the movement of users between spaced apart locations to located different discussions and allow face to face discussions during such movement between locations. In this embodiment, of the communications system the location includes a subject zone and a set of spaced apart locations define a discussion location. A plurality of pathways are provided and positioned between adjacent subject zones and adjacent discussion locations, the plurality of pathways having indicia at pathway junctions. The indicia can display information about at least one of subject zone locations and discussion locations to allow users to choose different pathways based on a user's desire to participate in discussion of a particular subject at a subject zone location or move to a different discussion location for consideration of participation in discussion for a particular subject.

The indicia can be either physical indicia for any user to see or the indicia can be displayed on a user's mobile device using the control means so that only the user of the mobile device can see information about the subject zone locations or discussion locations.

The pathways can be sized to allow face-to face discussions between users moving along the pathways or include face-to face discussion locations larger than the pathway and between locations to allow users to participate in discussions before reaching another location, and optionally the face-to face discussion locations are provided to one or more users through a user's mobile device. The users can also be provided with mapping information to the available discussion locations and subject zones through a mobile device to allow a user to select and/or follow a pathway direction for a desired discussion location or subject zone based on the mapping information.

The control means can allow a user profile to be registered with the system and the control means can group users together on a pathway using profiles of the users when a user seeks other discussion locations or subject zone locations through the user's mobile device.

The control means is one or more computers and its components and peripherals, e.g., processor(s), memory, printers, displays, wifi and bluetooth capability, internet connection, software, plug and play capability and the like that would include software designed to perform the functions described herein.

Yet another aspect of the invention is unique and advantageous uses of the communication system and communications method. In this embodiment, the invention provides a method of communication that allows the platform to be used in a number of different ways to enhance the user's experience, allow for revenue generation for a business or organization where the platform may be used, allow for revenue generation in terms of licensing the platform for use by others, and the like.

Different uses for the communication method and system can include one or more of the following:

a) the spaced apart locations can be located in a business or organization and an entry fee is charged to each of the plurality of users;

b) the spaced apart locations can be located in a business or organization and an owner of the business is charged a fee for using the method for communication;

c) one or more product or service advertisements or sponsorships can be displayed along with discussion topics or displayed subjects associated with the discussion topics and fees are charged for display of the product or service advertisement or sponsorships;

d) fees can be charged for each spaced apart location or fees can be charged for a plurality of spaced apart locations and, optionally, fees vary based on topics of discussion;

The communications system and method can also be used in connection with one or more of the following activities, events, or uses that would take place at the spaced apart locations:

events for the provision of financial services; creating focus groups, and optionally creating focus groups for market research or for product development or for political organizations; political events; cultural events; conventions; book fairs; trade shows; community events; civic events; personal development events; professional development events; improving communication within companies or organizations; improving communication between companies or between organizations; group therapy or other therapeutic use based on face-to-face conversation; providing social interaction for medical or therapeutic use; providing social connection for medical or therapeutic use; connection patient groups with related medical conditions for medical or therapeutic use; sharing experiences of medical conditions for medical or therapeutic use; teaching or learning communication, networking, or social skills for educational use; teaching and learning using face-to face networking for educational use; recruitment events, and optionally matching job applicants to employers; mediation events; including group or individual mediation; conflict resolution events; and dating events;

In the communications method or as part of the communications system, a database of users can be created showing who has participated in one or more structured networked discussions and charging a fee to a user to access the database, or offering a membership to a user for future access to structured networked discussions in one or more locations.

The spaced apart locations can be located in a business which provides networking events when using the communications method to attract customers to that business to increase revenue.

The business or organization can be charged a fee to host or to sponsor an event at the spaced apart locations or at a plurality of the spaced apart locations using the communication method.

A licensing fee can be charged for use of the spaced apart locations by a business other than the business or organization in which the spaced-apart locations are located.

While the business or organization can be virtually any type, preferred businesses or organizations include one of a nightlife business, a food and/or drink serving establishment, a retail merchant, a shopping mall, a dating service, a convention center, a conference or trade show organizer, a financial services provider, a marketing company, a public relations company, an events company, an events organizer, an entertainment company, a networking company, a social networking company, a business networking company, or a social media company, a university, an educational organization, or a training provider, a professional association, a personal development organization/business, a professional development organization/business, a business that provides audio visual services, a business that builds displays for conferences, conventions or for events, a business that provides technology or technical services for conferences, conventions or for events.

The communications method or system can also be used in connection with a networking event, and optionally wherein the networking event includes one of business networking, social networking, professional career networking, expert networking, and expert networking in areas including medicine and related professions, science, biotechnology, pharmaceuticals, technology, engineering, computing, electronics, digital technology. The communications method or system can also be used in connection with advertising or promotional or sales events; or advertising or promotional or sales events that involve face-to-face networking, or dating events involving face-to-face networking; or dating events involving matching individuals to each other, or dating events involving matching individuals who share interests a combination thereof. It is also possible that the system or method could be where more than one kind of event or activity described above would take place.

The communications system also includes a number of hardware and software features that improve or enhance the discussion experience for users or use of the system for administrator of the communications system. The features described can be used alone or in combination depending on the desire of the user or administrator of the system.

One feature is a plug and play feature, wherein a variable number of discussion signs and/or subject zone signs may be connected to the control means, wherein discussion signs and/or subject zone signs are assigned a unique address by the control means and stored therein, enabling data to be sent uniquely to each discussion sign and/or to each subject zone sign by the control means. Optionally, the control means can send a test signal after connection to each discussion sign, to the main display, and to subject zone signs to check that each are functioning correctly.

Another feature allows for an image to be created on the main display corresponding to each discussion sign and/or to each subject zone sign, wherein the image corresponding to each discussion sign and to each subject zone sign is able to display the same information as the corresponding discussion sign and subject zone sign.

A unique identifier can be displayed on each discussion sign and/or on each subject zone sign wherein the same identifier is associated with the image created on the main display (or on the control means) corresponding to each discussion sign and/or each subject zone sign to allow each discussion sign and/or each subject zone sign to be matched to its corresponding image on the main display (or on the control means).

The communications system also can include a configuration feature, wherein each discussion sign/and or subject zone sign is represented by a corresponding graphic on the main display (or on the control means), wherein each graphic may be dragged on-screen to a position corresponding to the position of the corresponding discussion sign/subject zone sign within the array of spaced apart locations, the display of the subject zone optionally having a different configuration than the display of the discussion topic sign.

Another feature allows a user to be able to allocate a discussion subject to a subject zone and the communication system displays discussion subjects in the same subject zone in the same color, and/or the system selects adjacent discussion signs to display discussion subjects that are in the same subject zone, and/or the system selects different colors for adjacent subject zones.

The communications system can also include a data interface to the Internet, enabling online users to see discussion subjects displayed on discussion signs and/or enabling discussion signs to be controlled remotely through the Internet.

The communication system can also be configured so that the signs have day or night settings for display of subjects and/or discussion topics and/or one or more of the subject signs and discussion topic sign associated therewith can be turned off during the event. One or both of each subject sign and discussion topic sign can also be amended during a given event with different subjects or different topics or colors.

The communication system also has archive capability so that information displayed on discussion signs and/or subject zone signs can be archived and the system can display some or all of that archived information at a later time.

Another aspect of the communications system and method is to enhance the user's experience by allowing users to participate remotely in a platform and to allow user input and other kinds of user participation to enhance the discussion being had.

In one aspect of this embodiment, the communications system can include a data interface between the at least one platform and one or both of a website and an app, the data interface enabling one or more users of the platform to: i) find out what's being discussed face-to-face at the one or more platforms, the users being online or physically present at the one or more platforms when using the data interface; ii) vote to create a new face-to-face discussion group; creation of new face-to-face discussion groups done remotely online before the one or more users arrive at the one or more platforms or the one or more users are physically present at the one or more platforms; iii) register to join a discussion group while at the one or more platforms or remotely online; and iv) create a new discussion group while physically present at the one or more platforms or remotely online.

The data interface between each of the one or more platforms and one or both of a website and an app enabling a plurality of users present at the one or more platforms or online to (i) propose ideas for new subject zones and new discussion group topics; ii) vote on proposed new discussion group topics; iii) vote for the most popular discussion topics to be chosen for face-to-face discussion at locations; and iv) vote on ideas discussed in face-to-face discussion groups.

For the communication systems, one of both of an App or website linked to the one or more platforms is capable of one or more of the following features: i) enabling popular and trending face-to-face discussion topics to be identified and displayed at platforms in different geographic locations; ii) enabling users to communicate online if the users are discussing the same subject (or related subjects) in platforms in different geographic locations; iii) enabling users to communicate online, if they are discussing the same subject or similar subjects in different groups in the same platform; iv) enabling users to have online discussions, which are related to the face-to-face discussions occurring in the one or more platforms; those users may be online or physically present in the one or more platforms; v) enabling users physically present in the one or more platforms to have face-to-face discussions, which are related to discussions occurring online; vi) enabling face-to face discussion locations and discussion signs at locations to only be identified by user smartphones/mobile devices; vii) enabling face-to face discussion locations and discussion signs at locations to be identified by user's smartphones by placing bar-codes or similar optical recognition indicia at physical locations; and viii) enabling users to text-message discussions, as well as audio and video discussions, which are related to the face-to-face discussions occurring in the one or more platforms; wherein users may or may not be physically present in the one or more platforms.

The communication system allows users with computers, smartphones or mobile devices to connect with each other and/or with the one or more platforms through wifi or bluetooth or other known telecommunication means, to achieve any of the functionality described in connection with the communication system and method.

Yet another aspect of the inventive communications system and method is improved configurations of the signs associated with the platform. That is, the one or more of the discussion signs can include transparent discussion sign so that the discussion topic appears written in the air at or near a discussion location. Optionally, the transparent discussion sign can be created by optical projection onto a semi-mirrored transparent surface, or the transparent discussion sign is created using OLED or QLED. The transparent discussion sign can have a day and night setting, wherein, in the night setting, for example at lower background light levels, text of the sign appears on a transparent background and wherein in the day setting, the text appears against a contrasting colored background for improved visibility.

Indicia can be included on the one or more discussion signs that is creatable by a smart phone or mobile device.

Other features that can be part of the discussion signs are one or more of the following: i) the one or more discussion signs can be associated with a discussion location by mobile devices including smart phones; ii) the one or more discussion signs can be associated with a discussion location by mobile devices using GPS technology and other location services; iii) the one or more discussion signs can be associated with a discussion location by mobile devices together with other mobile devices at a physical location; iv) the one or more discussion signs can be associated with a discussion location, by smart phones together with other smart phones at the same physical location; v) a discussion topic displayed on the one or more discussion signs can be associated with a location using a mobile device and either bluetooth or wifi; vi) discussion sign locations and face to face discussion locations are identifiable only by one or both of a smartphone or mobile device; and vii) discussion sign locations and face to face discussion locations are identifiable only by one or both of a smartphone or mobile device via bar codes or other optical recognition indicia at physical locations.

The one or more discussion signs can also be associated with an image or visual effect and optionally one or more of the following features: i) the image is still or moving, optionally the image is fire or water; ii) the image is still or moving, optionally the image is fire or water, and the discussion sign is projected within the image and the discussion sign text appears within the image as an area of greater brightness, darkness or in contrasting colors; and iii) the discussion sign is projected into smoke, fire, mist, steam or vapor at discussion locations or into any medium containing particles capable of creating an image through the Tyndall effect.

The one or more discussion signs can be associated with an actual fire or a fire effect and optionally the discussion signs form part of the actual fire or fire effect, or the discussion topic appears within the fire or fire effect, as an area of greater brightness, darkness or in contrasting colors.

### BRIEF DESCRIPTION OF THE DRAWINGS

FIG. 1 illustrates a conventional table which accommodates users and electronic sign-board.

FIG. 2 is a plan view of one embodiment of a conventional platform for facilitating face-to-face discussions.

FIG. 3 is an illustration of a display unit in connection with the platform of FIG. 2.

FIG. 4 shows color-coded discussion signs (1) and subject zone signs (3) a main display (5) which shows all subject zones and discussion topics, and users engaged in face-to-face conversation in a nightlife setting.

FIGS. 5A and 5B show examples of seating arrangements (7) and (9) for informal face-to-face discussions.

FIG. 6 shows a color-coded arrangement of spaced apart locations (11) and subject zone signs (13) for social networking in a nightlife setting.

FIG. 7 shows another embodiment of the color-coded arrangement of spaced apart locations (15) and subject zone signs (17) for an expert networking event in medical science.

FIG. 8 illustrates typical hardware components of an embodiment of the communication system, host computer (19), discussion signs (21), subject zone signs (23)

FIG. 9 shows the main display (25) or host computer display of the communications system with objects representing subject zone signs (29) and discussion signs (30), before configuration to a site.

FIG. 10 shows the main display (25) or host computer display of FIG. 8 after configuration to a site.

FIG. 11 shows the configuration of FIG. 10 on the host computer display (27) in operational mode.

FIG. 12 shows the main display (25) in operational mode.

FIG. 13 shows a night setting configuration for a discussion sign (33).

FIG. 14 shows a day setting configuration for the same discussion sign (33).

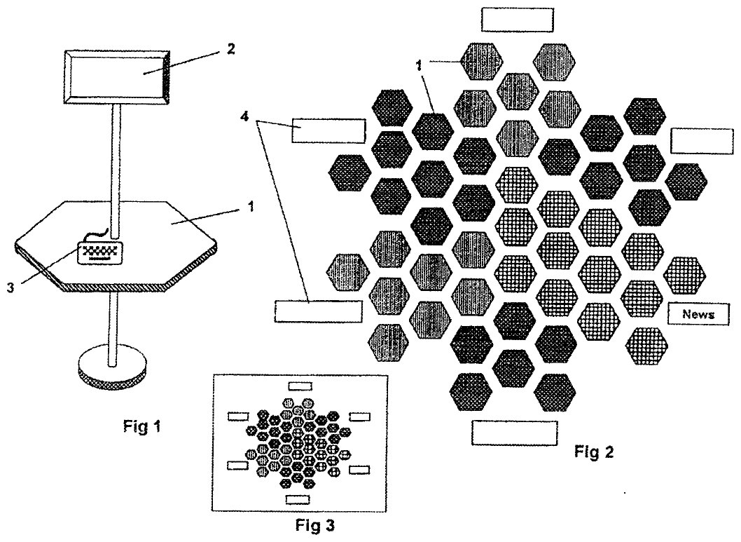

### DETAILED DESCRIPTION OF THE INVENTION

The inventive communications system and method provide a significant number of improvements over the platform of the prior art. These improvements and advantages include the following.

Pathway versions of the invention are a more dynamic variant, they structure user conversations as they move from one location to another, while tracking the mutation of discussion topics from one subject to another.

The functionality of pathway installations is significantly different to that of U.S. Pat. No. 7,111,244 and will give rise to a new and different user experience. For example, users may engage in conversation while walking together and can make different choices at physical junctions, leading to different outcomes. Pathway installations are well suited to certain types of thought and decision processes. Users may follow specific pathways led by indicia and mapped by their mobile devices, or users may create new pathways as a result of discussions, changing indicia and mappings through their mobile devices. Users may lead others or follow others. The mutation of discussions through pathway installations may be mapped and archived. Pathway installations may be built outdoors and may rely on a mobile device's location services.

At the same time, the functionality of pathway installations works very well together with the existing functionality of U.S. Pat. No. 7,111,244, which provides a platform for it.

U.S. Pat. No. 7,111,244 patent provided no information on how the invention might be monetized or used commercially to generate revenue. The '244 patent provided no information about business methods for its monetization and it only disclosed very limited uses of the invention. The invention describes many important new business activities and income generating events that are made possible by the invention. These new uses of the invention (at least) utilise its capacity to provide structured face-to-face networking. Each of these new business activities and income generating events can be done more efficiently and more productively than would otherwise be possible, without the use of the invention. This provides significant commercial advantage to any business or organisation that uses the invention for these activities or events. New uses of the invention include:
1. Advertising or promotional or sales events and/or advertising or promotional or sales events that involve face-to-face networking;
2. Networking events for the provision of business services or customer services;
3. Events for the provision of financial services;
4. Creating focus groups, and optionally creating focus groups for market research or for product development or for political organizations;
5. Political events;
6. Cultural events;
7. Conventions;
8. book fairs;
9. trade shows;
10. community events;
11. civic events;
12. personal development events;
13. professional development events;
14. improving communication within companies or organizations;
15. improving communication between companies or between organizations;
16. group therapy or other therapeutic use based on face-to-face conversation;
17. medical or therapeutic use by providing social interaction;
18. medical or therapeutic use by providing social connection;
19. medical or therapeutic use by connecting patient groups with related medical conditions;
20. medical or therapeutic use by sharing experiences of medical conditions,
21. educational use to teach or learn communication skills or networking skills or social skills;
22. educational use that involves teaching or learning by face-to-face networking;
23. use for recruitment events;
24. matching job applicants to employers;
25. networking between job applicants and employers;
26. mediation events, mediation between groups or individuals;
27. conflict resolution events;
28. dating events,
29. and optionally dating events involving face-to-face networking and/or dating events involving matching individuals to each other, and/or dating events involving matching individuals who share interests;
30. networking events arising from conferences or conventions; and networking events arising from conferences or conventions involving the creation of breakout groups,
31. business networking,
32. social networking,
33. professional career networking,
34. expert networking,
35. expert networking in areas including medicine and related professions, science, biotechnology, pharmaceuticals, technology, engineering, computing, electronics, digital technology.

Additionally, the inventive communications system and method provide new ways for businesses to monetise the invention and to derive commercial benefit from it, which were not outlined in the '244 patent. These new business uses and monetisation methods include the following:
1. The invention is located in a business or organization and an entry fee is charged to each of the plurality of users, who use the method of the invention
2. The invention is located in a business or organization and an owner of the business is charged a fee to practice the method of the invention.
3. One or more product or service advertisements or sponsorships are displayed by the invention along with discussion topics or displayed subjects associated with the discussion topics and fees are charged for display of the product or service advertisement or sponsorships.
4. fees are charged for each discussion location or fees are charged for a plurality of discussion locations, i.e., fees may be charged for a subject zone and, optionally, fees vary based on topics of discussion.
5. Creating a database of users who have participated in one or more structured networked discussions and charging a fee to a user to access the database, or offering a membership to a user for future access to structured networked discussions using the invention
6. The invention can be located in a business which provides networking events using the method of the invention to attract customers to that business to increase revenue A business or organization is charged a fee to host or to sponsor an event using the invention
8. A business or organization is charged a fee to host or sponsor discussion at one of the discussion locations within the invention or at a plurality of the discussion locations using the method of the invention.
9. A licensing fee is charged for use of the invention by a business other than the business or organization in which it is located.

The invention provides significant commercial advantage to certain businesses or organisations by providing a new revenue stream and/or by enhancing the existing business and/or by driving new customers to that business. These businesses or organisations may gain specific additional commercial advantage by having the invention located on their premises and/or by hosting the invention and/or by using the method of the invention, or by licensing the invention to another business or by licensing the method of the invention to another business.

Businesses or organizations where the invention is complementary to their existing business model and/or it is synergistic with it and/or the invention adds significant commercial value to that business/organization, include any of the following examples.

A nightlife business could use the invention to gain a new revenue stream by charging customers entry fees to use the invention to engage in conversation, or by any of the income generating steps 1-9 above. Additionally, the nightlife business could benefit by attracting new customers and increasing the sale of food and drink. The same applies to coffee shops and other food and/or drink serving establishments.

Convention centers, conference or trade show organizers could offer networking events (and other events and activities) using the invention, thereby gaining a new revenue stream by any of the income generating steps 1-9 above. Networking events (and other events) could be offered alongside existing conventions, conferences and trade shows. Alternatively, these networking events (and other events) could arise from existing conventions, conferences or trade shows. Events and activities using the invention could be incorporated into existing conventions, conferences and trade shows, attracting new customers to the existing business and generating more revenue.

Shopping malls and retail merchants could use the invention to generate a new revenue stream by offering face-to-conversation, by any of the income generating steps 1-9 above. Shopping malls and retail merchants, could use the invention to attract new customers to the existing business increasing retail sales. Additionally, the invention can be used to promote retail products as outlined above.

Events companies, events organizers, entertainment companies, networking companies, social networking companies or business networking companies could directly benefit commercially from the invention by using it to offer any of the events, activities, services, networking events or uses described above and by any of the income generating steps 1-9 above. Or they could generate revenue by licensing the invention or the method of the invention to other companies.

Social media companies and social networking companies could gain significant commercial advantage by offering face-to-face communication alongside online communication. They could also benefit significantly by offering hybrid face-to-face and online communication of the sort identified herein. Additionally, social media companies and social networking companies could benefit from the use of use invention and any of the income generating steps 1-9 above, particularly step 5 which involves creating a database of users.

Similarly, universities, educational organizations, training providers, professional associations, personal or business development organisations, or professional development organisations could benefit from the use of the invention to offer events and activities that are directly related to their core business. They could benefit commercially from any of the income generating steps 1-9 above.

A business that provides audio visual services; or a business that builds displays for conferences, conventions or for events; or a business that provides technology or technical services for conferences, conventions or for events, could benefit by building and installing the invention into other businesses. These businesses could also utilise any of the income generating steps 1-9 above. These businesses would benefit particularly from step 2 and step 9 by installing, selling, licensing and hiring the invention to other businesses.

The communications system of the '244 patent would have to be purpose built for each physical location of differing size and layout, which would be prohibitively expensive. Particularly, also where variable numbers of discussion signs or subject zones are required. The configurable communications system of the invention is re-usable, modular and adaptable —therefore suitable for mass-production and easier to install in any given location. The number of discussion signs and their specific locations is variable and configurable to a specific installation.

Plug and play feature enables hardware for discussion signs and subject zone signs to be added to the system, recognized by the software and then configured on screen to a specific layout, reflecting their position within the physical installation.

The user interface is much better than that of the '244 patent and the system provides new enhanced functionality. It can automatically allocate discussion signs in the colour of a subject zone. Discussion topics in the same subject zone can be allocated to adjacent locations within that subject zone. Similarly, adjacent subject zones can be automatically assigned different colours. Discussion topics and subject zone names can be archived, stored and then re-called and displayed when needed.

New features enable new hybrid forms of communication combining both face-to-face communication and online communication in ways that were not previously possible using internet technology alone, or face-to-face communication alone. These new features did not form any part of the '244 patent and provide important new functionality, new benefits and a better user experience. These new features enable online users and those physically present at installations to communicate with each other both face-to-face and/or online. These new features can enable online communication and face-to-face communication to modify each other and to enhance each other. This new functionality can produce a hybrid form of communication which is greater than the sum of its parts.

Additionally, new beneficial features are identified for users with computers, smartphones and mobile devices, to communicate with each other, and/or with the invention through those devices and/or to communicate face-to face in new ways, using new methods of the invention. Note: Individual installations of the invention are referred to here as a platform.

These new features enable users to communicate with each other face-to-face and/or online and to interact with one or more platforms. This includes users who are physically present at the same platform and/or physically present at different platforms and/or users who are only online. These new beneficial features of the invention include the following:

1. A data interface is provided between at least one platform and one or both of a website and an app, the data interface enabling one or more users of the platform to:
i) find out what's being discussed face-to-face at one or more platforms the users being online or physically present at the one or more platforms when using the data interface;
ii) vote to create a new face-to-face discussion group; creation of new face-to-face discussion groups done remotely online before the one or more users arrive at the one or more platforms or the one or more users are physically present at the one or more platforms;
iii) register to join a discussion group while at the one or more platforms or remotely online;
iv) create a new discussion group while physically present at the one or more platforms or remotely online;
   2. A data interface between each of the one or more platforms and one or both of a website and an app, the data interface enabling a plurality of users present at the one or more platforms or online:
(i) to propose ideas for new subject zones and new discussion group topics;
ii) to vote on proposed new discussion group topics;
iii) to vote for the most popular discussion topics to be chosen for face-to-face discussion at locations;
iv) to vote on ideas discussed in face-to-face discussion groups;
   3. One of both of an App or website linked to the one or more platforms, the app or website capable of one or more of the following features:
i) enabling popular and trending face-to-face discussion topics to be identified and displayed at platforms in different geographic locations;
ii) enabling users to communicate online if the users are discussing the same subject (or related subjects) in platforms in different geographic locations;
iii) enabling users to communicate online, if they are discussing the same subject or similar subjects in different groups in the same platform;
iv) enabling users to have online discussions, which are related to the face-to-face discussions occurring in the one or more platforms; those users may be online or physically present in the one or more platforms;
v) enabling users physically present in the one or more platforms to have face-to-face discussions, which are related to discussions occurring online;
vi) enabling face-to face discussion locations and discussion signs at locations to only be identified by user smartphones/mobile devices;
vii) enabling face-to face discussion locations and discussion signs at locations to be identified by user's smartphones by placing bar-codes or similar optical recognition indicia at physical locations; and
viii) enabling users to text-message discussions, as well as audio and video discussions, which are related to the face-to-face discussions occurring in the one or more platforms; wherein users may or may not be physically present in the one or more platforms.
   4. Users with computers, smartphones or mobile devices connect with each other and/or with the one or more platforms through wifi or bluetooth or other known telecommunication means, to achieve any of the functionality described here in 1-3 above.
   Discussion signs are defined within this application. Significant improvements are made to Discussion Signs providing benefits and an enhanced user experience as outlined below:
1. Discussion signs may be transparent which brings several advantages:
   1.1 The discussion topic appears ‘in the air’ above a discussion location, this creates an exciting look and feel and a unique customer experience, as if the user is ‘physically inside the Internet’.
   1.2 Transparent signs are unobtrusive when switched off.
   1.3 Transparent discussion signs afford a clear unimpaired view of other discussion signs across an installation of the invention.
   1.4 Transparent Discussion Signs may have different day and night settings to maximise visibility in different background light levels.
2. User smartphones and mobile devices can be utilised to create discussion signs at discussion locations, in any of the ways outlined below:
   2.1 discussion signs can be associated with a discussion location by mobile devices including smart phones;
   2.2 discussion signs can be associated with a discussion location by mobile devices using GPS technology and other location services;
   2.3 discussion signs can be associated with a discussion location by mobile devices together with other mobile devices at a physical location;
   2.4 discussion signs can be associated with a discussion location, by smart phones together with other smart phones at the same physical location;
   2.5 a discussion topic displayed on the one or more discussion signs can be associated with a location using a mobile device and either bluetooth or wifi;
   2.6 discussion sign locations and face to face discussion locations can be identifiable only by one or both of a smartphone or mobile device;
   2.7 discussion sign locations and face to face discussion locations are identifiable only by one or both of a smartphone or mobile device via bar codes or other optical recognition indicia at physical locations.
3. It is well known that fires and similar visual effects can stimulate conversation and discussion. Below are ways that these images and effects can be combined with discussion signs to enhance the look and feel of discussion locations, as well as improving the user experience.
   3.1 the image can be still or moving, optionally the image is fire or water, and the discussion sign is projected within the image and the discussion sign text appears within the image as an area of greater brightness, darkness or in contrasting colors;
   3.2 the discussion sign can be projected into smoke, fire, mist, steam or vapor at discussion locations or into any medium containing particles capable of creating an image through the Tyndall effect;
   3.3 discussion signs can be associated with an actual fire or a fire effect and optionally the discussion signs form part of the actual fire or fire effect, or the discussion topic appears within the fire or fire effect, as an area of greater brightness, darkness or in contrasting colors.

The following disclosure details improvements in the invention described in U.S. Pat. No. 7,111,244 (the '244 patent). For description purposes the system, providing face-to-face interaction between users, is referred to as the Platform.

The platform can be installed into various businesses, including nightclubs, cafes, conference and convention centers, and the like. The Platform can be licensed to the various entities controlling the sites that the platform is installed for short or long term use.

Portable, light-weight and temporary versions of the platform can be provided at a site. Additionally, the platform can be built in outdoor locations. Pathway versions of the platform can be constructed, which enable users to walk through installations while engaged in conversation.

An installation into client business venues will involve minimum disruption to the space of the business venue. The platform can be implemented at least as a ceiling hung array of transparent screens which are visually unobtrusive when switched off.

The Platform can be used together with ordinary furniture such as tables and seating, which form discussion locations. The transparent discussion signs can be hung above these locations. The platform can also include the necessary tables or other surfaces and seating that would interface with the various screens of the platform.

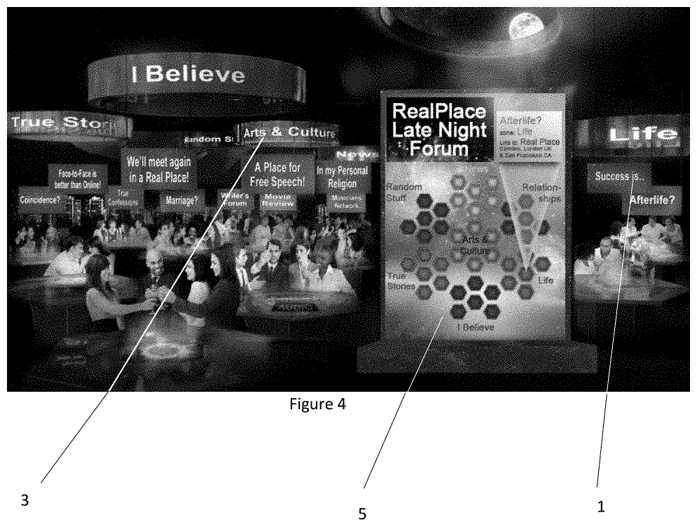

FIG. 4 is an exemplary image of an arrangement of components of the platform. Although this is just an illustration, the image does however correctly show some important features of the platform, including the overview, subject zone screens, e.g., ARTS AND CULTURE, and various topic screens (discussion signs) associated with a given subject screen, e.g., Movie Review. While tables are depicted as hexagonal, they can have any shape, including circular, square, rectangular, etc. FIG. 4 shows color-coded discussion signs (1) and subject zone signs (3) a main display (5) which shows all subject zones and discussion topics, and users engaged in face-to-face conversation in a nightlife setting.

The platform can be literally considered a real place—where people go to meet and talk in small groups. It enables users to network face-to-face and in-person. The platform can include an array of discussion locations where users can talk to each other in small groups, face-to-face in-person.

Each discussion location has a display screen or other indicia, which shows what is being discussed at that location. These refer to these indicia as discussion signs going forward. Discussion signs are typically placed respectively above tables and seating. A new discussion group can be created simply by displaying a new discussion sign at a given location.

In formal installations such as in convention centers, tables and chairs are used as discussion locations. In nightlife installations for social networking, soft circular seating can be placed at a low level for informal conversation. Or recessed ‘conversation pits’ can be provided.

The platform also can include a large display at the entrance, which gives an overview and shows what's being discussed at every table/seating location. It acts as a physical map of the platform as installed.

The platform also includes subject zones, which are regions made up of several discussion signs where related subjects are discussed. Preferably, a subject zone is color coordinated with the discussion signs related to the subject zones. The names of subject zones are indicated by display screens that can be relatively larger than the discussion signs to denote their group status as compared to the topics of the discussion signs.

Turning to the color coordination, each subject zone and related discussion signs can be illuminated in a desired color. Table tops can be lit in the color of the subject zone, if desired.

The platform can be configured to accommodate each individual customer space. All discussion locations can be mapped out on the large overview display, which can be conveniently located to an entrance to a location where the platform is installed.

One or more platform operators can control all of the subject zone and discussion signs from a single computer, and can welcome visitors at the entrance to the location where the platform is installed.

One or more discussion coordinators can be provided that can walk the installation, setting up new groups and moderating any discussions, if needed. Discussion coordinators can be in radio contact with each other, through head-sets or the like.

One aspect of the invention is the fact that the discussion signs can be transparent. With this feature, the following effects can be achieved:

1. the discussion topic appears written in the air above the table;

2. transparent signs do not obscure the view;

3. when the signs are switched off they are hardly noticeable and not intrusive; and

4. day and night settings for the signs are available in different light levels, wherein at night, text on discussion signs appears very brightly on a transparent screen and in the day, the text appears in black (or in white) on an opaque screen, which is typically in the color of the subject zone.

The platform and its components can be designed with a ‘look and feel’ which gives the user the experience of being ‘physically inside the Internet’. Discussion locations in nightlife installations are friendly and intimate with a fireside quality. Displays can be put at the center of one or more seating areas—typically something relaxing and inspiring like fire or water. Platform installations for conventions and business networking can have a more formal appearance.

The platform can be implemented as a computer driven array of transparent electronic display screens, in accordance with that detailed in the '244 patent and with the following improvements.

1. Display screens can be light-weight and transparent—such as transparent OLED.

2. Discussion signs can be transparent LCD displays illuminated with colored light.

3. LCD projectors can be utilized to illuminate semi-mirrored glass to create discussion signs.

4. Discussion signs can also be created at a location by optical projection.

5. Discussion signs can also be created at a location by scanning lasers.

6. Discussion signs can be associated with a discussion location, by mobile devices including smart phones.

7. Discussion signs can be associated with a discussion location, by mobile devices using GPS technology and other location services.

8. Discussion signs can be associated with a discussion location, by mobile devices together with other mobile devices at a physical location.

9. Users can be grouped together at face-to-face discussion locations through their smart devices, by ‘pairing’ those devices through WI-FI or blue-tooth.

10. Discussion signs can be associated with a discussion location, by smart phones together with other smart phones at the same physical location.

11. Mobile devices at a specific discussion location can associate a discussion topic with a location by Bluetooth or WI-FI.

12. Face-to face discussion locations and discussion signs at locations can be identified only by user smartphones/mobile devices.

13. Face-to face discussion locations and discussion signs at locations can be identified by smartphones by placing bar-codes or similar optical recognition indicia at physical locations.

14. Discussion signs can be associated with discussion locations by smart glasses which augment a physical location with a visual display.

15. Discussion signs can be associated with discussion locations by wearable technology such as smart watches.

16. Display screens (discussion signs) can be suspended from the ceiling using wires and power used for lighting.

17. The platform can be modular in construction and can accommodate any number of discussion signs and discussion locations.

18. A very large display unit at the entrance gives an overview and shows what's being displayed at every location—as well as the colors of subject zones and the names of subject zones. The display unit should be sufficiently large so that a group of people can view it at once—to gain an overview of all discussion topics and all subject zones. This overview display unit need not be transparent.

Beside the physical components of the platform, i.e., the screens, display unit for the overview image, the optional surfaces such as tables and seating, the platform will include both hardware and software to permit the platform to function as a place where people can interact face-to-face and/or in parallel online, based on various subjects and topics for discussion and people can remotely know what is happening or about to be happening in connection with the platform using an app on a mobile device or other computer device, or the internet using a website.

The platform can be driven by customized software to control the displays that are part of the platform, whether it be the overview, subject zones, discussion signs, the app that provides access to the platform, etc.

The operation of the platform can be implemented as a purpose-built digital signage system with the functionality specified here. The digital content is text and graphics as described herein.

The platform can be highly generic, i.e., any type of TV/monitor screen can be used with the software and the hardware.

The system can be modular—any number of discussion signs can be added in—and shown on the main display—in positions corresponding to their position in the physical installation.

The transparent screens above tables can be transparent OLED (preferred), transparent LCD displays (backlit) or mirrored glass screens illuminated by LCD projector. Discussion signs can be created by projection. The screens at any one installation can be driven by Wi-Fi from one computer with a Wi-Fi plug-in though standard HDMI, DVI or VGA inputs. The platform can also be implemented as a LAN/Intranet. The system can have automatic plug and play when screens/discussion signs are connected to it.

Screens (discussion signs) can be hardwired or can be controlled by blue-tooth or WI-FI.

Scanning lasers can be used to create discussion signs at locations.

The digital signage system that drives the platform can also be web-based.

The platform can also be implemented entirely locally as a LAN/Intranet.

Individual screens (discussion signs) can be identified as separated HTML webpages on an intranet. Individual display screens (discussion signs) can be identified as separate HTML webpages on an external website.

The software controlling the platform would be easy and intuitive to operate from a single host computer. That is, the software should make it very easy for a platform operator to set-up and change discussion signs on screens. The software that forms part of the updated invention makes it very easy to set up and change the names and colors of subject zones. The software should also be configured so that it can regularly archive and back-up all discussion signs and subject zones with dates and times.

As described above, subject zones define a broader topic that encompasses the topics that may be displayed in a number of discussion signs. Display units larger than the discussion signs can be used to name subject zones so as to differentiate the subject zone topic from the discussion sign topics. Typically, one subject zone sign is provided for a group of tables/discussion signs. The subject zone sign can be surrounded by tables/discussion signs as shown in the diagram above or in the '244 patent.

One or more surfaces can be provided for people forming a group for a given discussion sign. These surfaces can be tables for formal business networking, for example, round ones that range from 3 to 5 feet in diameter, such as a 42-inch table to adequately seat six people. The seating for a given table can be any type but it is preferred that the seating is fixed and at a low-level to avoid blocking access. Center pieces can be placed on tables, i.e., visual displays—such as fire or water or abstract images—as a focal point for discussion.

As an addition to a number of discussion signs, one very large discussion location—enabling a large number of user to discuss/debate a topic can be provided. The much larger discussion location can take the form of a large ‘conversation pit’ or a small amphitheater. The above large discussion location for larger debates can be recessed into the floor of the installation or built on a raised platform. The above large discussion location can be provided with a much larger discussion sign.

While the subject zones and related discussion signs can be in one open area, subject zones can be accommodated in different rooms. As well, subject zones can be accommodated on different levels of an installation, can be built on raised platforms and/or on balcony areas and/or can be recessed into lower level areas of an installation.

Another aspect of the invention relates to pathways in the installation that arise as a result of the establishment of different subject zones areas, or to different discussion locations. That is, there could be designated or identified pathways throughout the space occupied by the platforms. These pathway installations can provide users with different pathways enabling them to choose different paths through installations, i.e., different routes between discussion locations and subject zones.

Pathway installations can provide indicia at path junctions, enabling users to choose different paths leading to different discussion topics. The pathway installations can be built outdoors—along natural pathways in the physical environment. The platform can be located outside or different zones can be connected by an outside space.

Pathway installations can be built inside tunnel networks which provide different paths.

When using the pathways, users can walk together through a pathway installation so as to be grouped together for enhanced face-to-face interaction.

Users can also be grouped together for walking through a given pathway installation through their smartphones or mobile devices, by Bluetooth or WIFI.

The pathway installations can be mapped-out only by user smartphones/mobile devices so that only the users are privy to the pathway and no other indicia are required.

The pathway installations can provide face-to-face discussion locations and these can be mapped out only using GPS/location services and user smartphones/mobile devices. User smartphones/mobile devices can also indicate the choice points between different physical pathways in pathway installations so that users can decide which pathway may be of most interest.

Some installations can allow tables to be illuminated in the color of the subject zone.
The area for a given discussion location can also employ noise dampening technology so as to create a conversation bubble. Known noise dampening technologies and materials for three dimensional spaces, e.g., sound absorbent surfaces for a discussion group, could be employed in connection with the table and seating so that the discussions of one group of people at one discussion location would minimally interfere with the discussion of another group of people at another discussion location. Since this three dimensional noise dampening technology is well known, a detailed description is not necessary for understanding of this aspect of the invention.

As noted above, the seating for the platform may be provided as part of the platform or be independently provided by someone other than the platform provider.

Different seating, space, architecture, design, and acoustic arrangements can be used depending on the specific venue of the platform.

Seating for Nightlife Venues
Informal seating could be provided instead of tables at nightlife venues
Circular (ring shaped soft seating) can be placed below signs to create a campfire feel. Simulated fire-effects and visual displays can be put at the center.
Conversation pits can be created in purpose-built platform installations. FIGS. 5A and 5B show examples of seating arrangements (7) and (9) for informal face-to-face discussions.

Space and Acoustic Requirements

1. The platform is able to utilize spaces without natural lighting very effectively.

2. The environment can be made acoustically soft to reduce excessive noise.

3. Soft furnishings and sound absorbent surfaces improve a discussion location—noise cancelling technology can be used to create private ‘conversation bubbles’ at discussion locations. Discussion locations can be made acoustically soft and sound insulation can be used in densely packed spaces.

Platform Architectures and Design Themes

Platform installations may be themed with natural features such as plants, rocks, water features, beach scenes, images of sunsets. Creating purpose-built platforms can offer exciting challenges for designers and architects. The platform may also be constructed in outdoor locations incorporating existing natural features.

The platform can also be configured based on a specific customer's location and examples of configurations include the following.

1. Preferred embodiments are ‘plug and play’, when screens (or discussion signs) are added to the system, the software recognizes them.

2. The system recognizes screens (discussion signs) from WI-FI plug-ins (or from other hardwired connection), it allocates a number to each discussion sign which can be represented on the large display screen (also on the controlling computer).

3. Tables and discussion signs (may for example be represented as circles) they can be positioned on the large screen to reflect their actual position in the physical installation.

4. Boxes to name whole subject zones can be positioned on the display screen and the host computer. These will correspond to the large subject zone signs.

Functionality of the hardware and/or software can include one or more of the following features.

1. Colors and names of subject zones can be easily inputted and updated from the controlling computer by an operator.

2. Discussion topics are easily inputted by the operator on the host computer and displayed on the discussion signs (above tables) always in the color of the subject zone.

3. Discussion topics are displayed on the controlling PC and simultaneously on the large display that gives an overview of the whole platform—preferably in the color of the subject zone.

4. Names of subject zones are also displayed on large subject zone signs covering a group of tables, i.e., covering several discussion signs and tables.

5. On the overview display—tables/seating can be represented by circles and discussion subjects appear as rectangles inside the circles.

6. On the overview display—subject zones are shown inside large rectangles—associated with a group of tables all in the same color. Subject zones are also associated with a large display which shows the name of the subject zone in the physical installation.

7. All the above can be easily updated and amended from the controlling PC.

8. Any number of discussion signs can be added to subject zones—always in the color of the subject zone.

9. Discussion signs remain transparent when not in use—even when other signs are activated.

10. The software should be configured regularly archive and back-up all information related to discussion signs, subject zones, and display overview, and other information important for archiving purposes, customers, venue, etc.

11. On the night-setting, text on discussion signs appears very brightly on the transparent screen with transparent background. (text is in the color of the subject zone).

12. In the daylight-setting, the text appears in black (or in white) or as a colored opaque background, which is preferably the color of the subject zone.

13. Software must be fully encrypted and locked requiring individual activation codes to prevent piracy.

14. The software can automatically cluster related discussion topics into subject zones.

15. The software is able to automatically allocate adjacent tables (discussion locations) to related discussion topics which are within the same subject zone.

The platform also includes a feature where remote online monitoring and control of installations can be practiced and parallel face-to-face and online discussion groups can be arranged.

In this embodiment, the software which controls the platform connects to a website for activation and monitoring. Online users can log in to a website or use an App on a mobile device to see what is being discussed at each platform installation.

A customer business registration system can be implemented as part of the website or App as it would relate to the business into which the platform is installed. This would include obtaining and registering business names and addresses, setting hours and days of operation, and requiring activation codes for participation in an online or in person activity. Monthly reactivation from a website for example on payment of license fees can also be part of the system.

Other features of functionality include:

a) discussion signs can be controlled remotely online and through the Internet;

b) subject zones can be controlled remotely online and through the Internet;

c) a website and/or an App can be created which enables users to find the nearest platform, i.e., the nearest local installation(s) of the platform;

d) the website and/or the App enables users find out what's being discussed at each platform installation;

e) the website and/or the App enables users to vote to create a discussion group; users may do this remotely online before they arrive at the installation—or while physically present at an installation;

f) the website and/or the App can enable users to register to join a discussion group while at an installation or remotely online.

g) the website and/or the App enables users to ask to create a new discussion group while physically present at an installation or remotely online;

h) members of groups physically present at installations or online can propose ideas for subject zone and discussion sign topics, which can be recorded online;

i) members of groups physically present at installations and those online can vote on the ideas online;

j) users online or those physically present at an installation can vote and the most popular discussion topics are chosen for discussion signs at locations;

k) popular ‘trending discussion topics’ can be identified and displayed at a number of different platform installations in different geographic locations;

l) the App or website enables users to communicate online if they are discussing the same subject (or related subjects) in different physical installations in different geographic locations;

m) the App or website enables users to communicate online, if they are discussing the same subject or similar subjects in different groups in the same physical installation;

n) the App or website enable users to have online discussions, which are related to the face-to-face discussions occurring in the physical installations; those users may be online or physically present in installations;

o) the App or website enables users physically present in installations to have face-to-face discussions, which are related to discussions occurring online;

p) face-to face discussion locations and discussion signs at locations can be identified only by user smartphones/mobile devices; and

q) face-to face discussion locations and discussion signs at locations can be identified by smartphones by placing bar-codes or similar optical recognition indicia at physical locations.

r) The App or website can enable users to text-message discussions, as well as audio and video discussions, which are related to the face-to-face discussions occurring in the physical installations; participating users may or may not be physically present in installations;

s) The Mobile App or website can enable discussion signs to be operated and amended remotely online or locally.

r) The Mobile App or website can enable subject zone signs to be operated and amended remotely online or locally.

Turning back to the registration system, users of the platform can be registered, enabling the following functions.

1. Users can be given an ID which is the same as their real-life identity which confirms exactly who they are. One or more of the registered users, the ID, the registration system could be branded for example as ‘Real People’.

2. This ID enables registered users of the platform to confirm who they are, so that other registered users know exactly who they are talking to, which is in contrast to the Internet where users do not know who they are speaking to.

3. Registered users can be invited to events which are only and exclusively for other registered users.

4. Registered users can use their ID to pay for use of the platform.

5. Registered users can use their ID to gain physical access to the platform.

6. Registered users can be given priority access to the platform as well as privileges associated with membership of the registration scheme.

Other features of the invention relate to following the progression of discussions being had amongst the groups and providing indications of such progressions. The features may include the following.

1. Additional signs (indicia) or the discussion or subject zones signs can indicate progression from one discussion location to another as discussions progress and mutate.

2. The signs (indicia) indicating progression from one discussion location to another can be implemented as arrows, or as illuminated tracks along the ground or the ceiling leading from one location to another.

3. Signs (indicia) can be used to display user progression from one subject/location to another subject/location.

4. Signs (indicia) can be used to lead users from one subject/location to another.

5. Users can be tracked as they progress from one discussion topic/discussion location to another.

6. Users can be tracked through their smartphones/mobile devices. For example, their devices can be tracked through blue-tooth or WI-FI connection.

7. The mutation of discussion topics can be tracked separately for each user (through their mobile devices) as they move to each new discussion location.

8. The mutation of discussion topics can be tracked for groups of users (through their mobile devices) as they move from one discussion location to another.

9. The mutation of discussion topics can be tracked at each location as the subject displayed on the discussion sign changes through time.

10. The signs (indicia) indicating progression from one discussion location to another, can be operated and amended locally, or remotely

11. The signs (indicia) indicating progression from one discussion location to another, could be operated and amended through a host computer controlling the platform.

12. The signs (indicia) indicating progression from one discussion location to another, could be operated and amended remotely online or locally, through a website or a mobile app.

13. User trajectory progressing from one discussion topic/discussion location to another, can be stored in a computer memory.

14. User trajectory as they progress from one discussion topic/discussion location to another can be displayed.

15. The mutation of discussion topics from one subject to another can be archived.

16. The mutation of discussion topics from one subject to another can be displayed.

The various features listed above, e.g., the use of transparent signs to facilitate the display of subject and discussion tops, the use of noise cancelling technology for the discussion sign groups, creation of a web site and mobile device app and the linking of the website or App to the platform to provide a connection between the activities occurring at the platform installation and online participants for the purpose of discussions, changing topics, etc.; a control system with its associated software that allows the various functionalities described above to take place; the use of a customer registration system to maintain a database of people participating or wanting to participate in platform activities and/or online-related platform activities, different types of seating and surfaces depending on the venue of the platform, differentiation between the sizes of signs for subject zones and the sizes of discussion locations, discussion signs, pathway installations that users can walk-through, and optionally tables and/or seating, day/night setting for the signs of the platform, providing ways to monitor and display progressions in the subject zone and/or discussion sign topics for attendees of the platform and/or online activity, are all improvements over the disclosure of the '244 patent and provide an improved platform that offers face-to-face interaction as an alternative to current Social Media which only exists via the internet.

Besides the features of the invention described above in connection with U.S. Pat. No. 7,111,244 (the '244 patent), additional features are described below. As with the features above, the system, providing face-to-face interaction between users, is referred to as the Platform.

The Platform can be literally considered a real place—where people go to meet and talk in small groups. It enables users to network face-to-face and in-person. The Platform can include an array of discussion locations where users can talk to each other in small groups, face-to-face in-person.

Each discussion location has a display screen or other indicia, which shows what is being discussed at that location. These indicia are referred to as discussion signs going forward. A new discussion group can be created simply by displaying a new discussion sign at a given location.

The Platform also includes subject zones, which are regions made up of several discussion signs where related subjects are discussed.

Additional and new commercial uses and refinements of the invention in terms of the inventive apparatus and method are provided, the additional uses and refinements over and above those described above and in U.S. Pat. No. 7,111,244.

The first listing relates to new commercial uses of the Platform and they are enumerated below.

### A. Commercial Uses

1. Use of the Platform by Nightlife Businesses, to create a revenue stream by charging customers entry fees, for the provision of face-to-face social networking events.
2. Use of the Platform by nightlife businesses to provide social networking and/or face to face social interaction and/or social connection between participants and/or to promote conversation between users.
3. Licensing the Platform to Nightlife Businesses for the services described in items 1 and 2.
4. Use of the Platform by Nightlife Businesses to attract customers, to increase the sale of food and drink.
5. Use of the Platform by cafes, restaurants, bars or coffee shops, to create a revenue stream by charging customers entry fees, for the provision of face-to-face social networking events.
6. Use of the Platform by cafes, restaurants, bars and coffee shops to provide social networking and/or face to face social interaction and/or social connection between participants and/or to promote conversation between users.
7. Licensing the Platform to cafes, restaurants, bars and coffee shops for the services described above.
8. Use of the Platform by cafes, restaurants, bars and coffee shops to attract customers, to increase the sale of food and drink.
9. Use of the Platform by dating companies to facilitate face-to-face introductions for customers, who share interests.
10. Use of the Platform by retail businesses and retail spaces, including shopping malls, to drive customers to the business to increase sales.
11. Use of the Platform for business networking and/or expert networking.
12. Use of the platform for break-out groups for conferences.
13. Use of the Platform by convention centers, to create a new revenue stream, by charging customers for the provision of face-to-face networking and/or business networking and/or expert networking and/or professional networking services.
14. Use of the Platform by conference organizers, to create a new revenue stream, by charging customers for the provision of face-to-face networking services, business networking and/or expert networking and/or professional networking services.
15. Licensing the Platform to convention centers and/or to conference organizers.
16. Use of the Platform to receive sponsorship for business networking events on the platform.
17. Selling business networking events on the Platform to companies/organizations/conference organizers.
18. Selling the use of/hire of the Platform to conference organizers and/or convention centers.
19. Selling tables at business networking events on the platform to companies and other organizations.
20. Selling subject zones within networking events on the platform to companies and other organizations.
21. Receiving revenue from companies/organizations advertising on discussion signs on the Platform.
22. Receiving revenue from companies/organizations selling products and services in-person at discussion locations on the Platform.
23. Receiving revenue from companies/organizations demonstrating products and services in-person at discussion locations on the Platform.
24. Receiving revenue from companies/organizations giving samples of products and services in-person at discussion locations on the Platform.
25. Use of the Platform for advertising and promotions that involve face-to-face networking events.
26. Use of the Platform to create focus groups for market research.
27. Use of the Platform for product development.
28. Use of the Platform to create focus groups for political organizations.
29. Use of the Platform for cultural events.
30. Use of the Platform for trade shows.
31. Use of the Platform for book fairs.
32. Use of the Platform for community and civic events.
33. Use of the Platform for public consultations.
34. Use of the Platform for conventions.
35. Use of the Platform for personal development events.
36. Use of the Platform for professional development events.
37. Use of the Platform to improve communications within companies and/or organizations.
38. Use of the Platform to improve communications between companies and/or between organizations.
39. Use of the Platform for the provision of financial services.
40. Use of the Platform for group therapy and/or other therapies based on face-to-face conversation.
41. Medical and therapeutic use of the Platform by providing social interaction.
42. Medical and therapeutic use of the Platform by providing social connection.
43. Medical and therapeutic use of the Platform by connecting patient groups with medical conditions and illnesses.
44. Medical and therapeutic use of the Platform by sharing experiences of medical conditions and illnesses.
45. Educational use of the platform to teach/learn communication skills.
46. Educational use of the platform to teach/learn networking skills.
47. Educational use of the platform to teach/learn social skills.
48. Educational use of the platform involving teaching/learning by networking
49. Educational use of the platform involving teaching learning through verbal communication.
50. Use of the Platform for recruitment events.
51. Use of the Platform to match applicants to employers.
52. Use of the Platform for networking between applicants and employers.
53. Use of the Platform for mediation between groups between individuals.
54. Use of the Platform for conflict resolution between groups/between individuals.
55. Selling individual seats at discussion locations to attendees at networking events/business events.
56. Selling tables/discussion locations to other companies/organizations to host discussions at business events/networking events.
57. Selling whole subject zones to other companies/organizations to host discussions at business events/networking events.
58. Selling the temporary use of the whole platform to other companies/organizations to host events.
59. Selling access to the platform to attendees wishing to participate in business events/networking events.
60. Creating a database of registered users of the platform and selling them access to it at one or more installations.
61. Creating a database of registered users of the platform and offering them membership, enabling them to access the platform at one or more installations.

Besides the new commercial uses relating to the Platform as listed above, other features of the invention are detailed below in connection with the discussion signs and discussion locations.

### B. Discussion Signs and Locations

1. Discussion signs are optically projected at discussion locations or near discussion locations by an LCD projector or other known projection device.
2. Discussion signs can be projected onto transparent/translucent screens, to create the illusion that the discussion topic appears in the air, close to discussion location.
3. Discussion signs can be projected onto partly mirrored transparent screens, to create the illusion that the discussion topic appears in the air, close to the discussion location.
4. Where some of the light from the projector used to create a discussion sign also illuminates a table at that discussion location in the color of the subject zone associated with that discussion sign.
5. Where some of the light from the projector used to create a discussion sign also illuminates the discussion location in the color of the subject zone associated with that discussion sign.
6. Where some of the light from the projector used to create a discussion sign also illuminates the ceiling above a discussion location in the color of the subject zone associated with that discussion sign.
7. Where some of the light from the projector used to create a discussion sign also illuminates a table at that discussion location in the color of the subject zone associated with that discussion sign, and also projects the discussion topic onto that table.
8. Where some of the light from the projector used to create a discussion sign also illuminates that discussion location in the color of the subject zone associated with that discussion sign, and also projects the discussion topic onto a surface at that discussion location.
9. Where some of the light from the projector used to create a discussion sign also illuminates the ceiling above that discussion location in the color of the subject zone associated with that discussion sign, and also projects the discussion topic onto the ceiling.
10. Discussion signs can be projected onto the ceiling above discussion locations.
11. Discussion signs can be projected within a pleasing image (such as fire, water, sunsets).
12. Discussion signs can be projected within a pleasing image (such as fire, water or sunsets) wherein the image is moving.
13. Discussion signs can be projected onto the ceiling above discussion locations within a pleasing image (such as fire, water, sunsets).
14. Discussion signs can be projected onto the ceiling above discussion locations within a pleasing image such as fire, water, sunsets, wherein the image is moving.
15. Discussion signs can be projected onto a table, floor or place close to discussion locations.
16. Discussion signs can be projected onto a table, floor or other or place close to discussion locations within a pleasing image such as fire, water, sunsets.
17. Discussion signs can be projected onto a table, floor or other surface at discussion locations within a pleasing image such as fire, water, sunsets.
18. Discussion signs can be projected onto a table, floor or other or place close to discussion locations within a pleasing image such as fire, water, sunsets, wherein the image is moving.
19. Discussion signs can be projected as a holographic image above discussion locations.
20. Discussion signs can be projected within a pleasing image such as fire, water, sunsets in a holographic image above discussion locations.
21. Discussion signs can be projected into smoke, fire, mist, steam or vapor at discussion locations.
22. Discussion signs can be projected into any medium containing particles which is capable of creating an image through the Tyndall effect.
23. Discussion signs can be projected above discussion locations outdoors into the sky—particularly at night.
24. Discussion signs can be projected above discussion locations outdoors on rooftops—particularly at night.
25. Where a user writes the discussion topic onto a surface which is projected onto a screen at a discussion location, through a known arrangement of light source, lenses and/or mirrors.

Besides the commercial uses above and embodiments involving the discussion signs and discussion locations, additional features of the invention are listed below.

### C. Additional Variants

1. Where actual fires or artificial fire effects are placed at discussion locations and discussion signs form part of those fires or fire effects, i.e., where the discussion topic appears within the fire/fire effect, as areas of greater brightness, darkness or in contrasting colors.
2. Where other visual effects (such as of moving water) are placed at discussion locations, where discussion signs form part of the visual effects, i.e., the discussion topic appears within those effects, as areas of greater brightness, darkness or in contrasting colors.
3. Subject zones can be identified by an image such as a picture, photo, moving image, gif, a symbol or an emoticon.

The following provides additional features of the invention in terms of a top level specification for a possible embodiment of the Platform, and this includes primary features of a possible embodiment the Platform, the look and feel of a possible embodiment of the Platform from a customer viewpoint, a technical specification of an embodiment and its functionality.

Primary Features of One Embodiment of the Platform

The platform will be installed into nightlife businesses, cafes, convention centers and other spaces as a permanent installation. The owners of the Platform will own the software and the hardware which will be licensed to the Platform's customers/users.

Installation into customer venues will involve minimum disruption to their space. The Platform is a ceiling hung array of transparent screens which are visually unobtrusive when switched off.

The Platform is used together with ordinary furniture such as tables and seating, which form discussion locations. The transparent discussion signs are hung above these locations.

FIG. 4 is just an artist's impression—it does however correctly show some important features of the Platform. Tables can be circular and not hexagonal as shown below.

FIG. 4 shows color-coded discussion signs (1) and subject zone signs (3) a main display (5) which shows all subject zones and discussion topics, and users engaged in face-to-face conversation in a nightlife setting.
1. The Platform literally creates a real place—where people go to meet and talk in small groups. It enables users to network face-to-face and in-person.
2. The Platform consists of an array of locations where users can talk to each other in small groups, face-to-face in-person.
3. Each discussion location has an electronic sign which shows what is being discussed and these as called discussion signs.
4. Discussion signs are place above tables and seating.
5. A new discussion group is created simply by displaying a new discussion sign at a location.
6. In formal installations such as in convention centers, tables and chairs are used as discussion locations.
7. In nightlife installations for social networking, soft circular seating is placed at a low level for informal conversation.
8. A large display at the entrance gives an overview and shows what's being discussed at every table/seating location. It is a physical map of the Platform installation.
9. Subject Zones are regions, consisting of several discussion signs where related subjects are discussed. They are created by using the same color for all those discussion signs.
10. The names of Subject Zones are indicated by larger screens.
11. Entire subject zones can be illuminated in the same color, table tops can be lit in the color of the subject zone.
12. Our platform will be configured to each individual customer space. All discussion locations are mapped out on the large display at the entrance to the Platform location, when it is installed.
13. One platform operator will control all of the discussion signs from a single computer, and will welcome visitors at the entrance to the location where the Platform is located. At least one other discussion coordinator will walk the installation, setting up new groups and moderating any discussions if needed. Both discussion coordinators will be in radio contact with each other, through head-sets.

The discussion signs are transparent such that they appear written in the air above the table. Transparent signs do not obscure the view. When the signs are switched off they are hardly noticeable and not intrusive. Day and night settings are required in different light levels. At night, text on discussion signs appears very brightly on a transparent screen. In the day, the text appears in black (or in white) on an opaque screen, which is typically in the color of the subject zone.

Look and Feel

The space is exciting and futuristic as if you are physically inside the Internet. Discussion locations in nightlife installations are friendly and intimate with a fireside quality. Displays can be put at the center of seating areas—typically something relaxing and inspiring like a fire or water. Platform installations for conventions can have a more formal appearance. The Customer Experience. The two typical customer stories below explain the look and feel of the platform and describe a typical customer experience.

### Specifying the ‘Look and Feel’ of a Possible Embodiment of the Platform and the User Experience

### User Experience 1 of a Possible Embodiment of the Platform

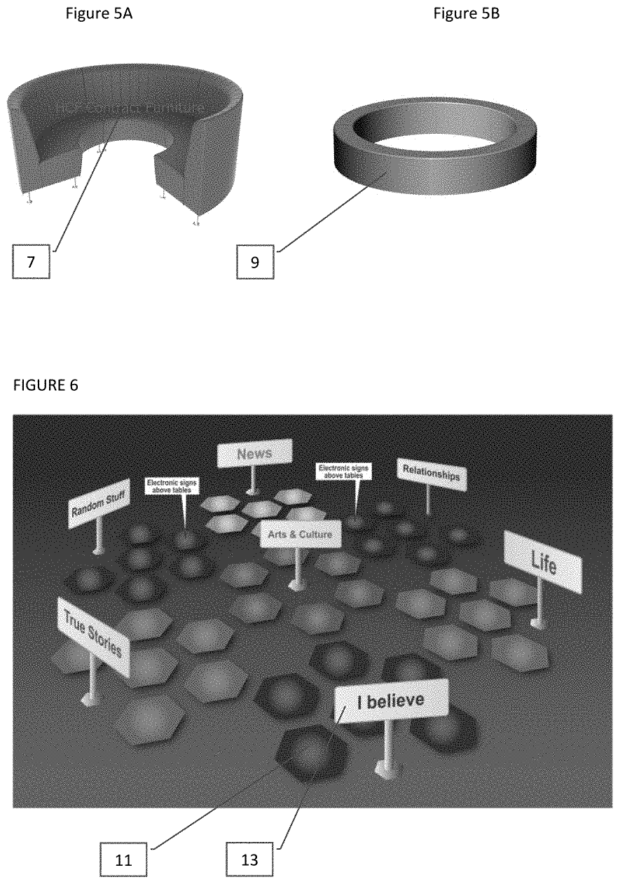

See FIG. 6 which shows a color-coded arrangement of spaced apart locations (11) and subject zone signs (13) for social networking in a nightlife setting.

Nightlife Customer Experience:

As I walk into the location where the Platform is located, it feels like I'm physically inside the Internet—everything is lit up in electric colors. But people are talking to each other face-to-face—in real-life. I can see a big display at the entrance—it shows all the things that people are discussing—hundreds of different conversations running late into the night. I ask the guy if I can join a group on ‘True-Crime Podcasts’. He says he'll set one up for me. People are chatting in small friendly groups—looks like they're sitting around fires—but they're not real fires—I don't think so! Above them are electronic signs showing what they're discussing—the signs are transparent—so the words just appear in the air. Then my sign appears in the distance—in the Turquoise Zone (Arts and Culture)—it says ‘True Crime Podcasts’. By the time I get there, four other people have joined us. One of them actually makes a Podcast show—she said she would look at some of my stuff—which was a good bit of networking—which I wasn't expecting to happen. On the way, I noticed people in the Purple Zone talking about ‘Relationships’. There's no way I would discuss personal stuff like that with strangers. But later I did! There was a group talking about ‘Pointless Arguments’. It was quite funny actually. Then I joined a group in the random zone on Starting your own Business it's not really something I'd ever thought about—but the people looked interesting. That's the big advantage of face-to-face over the Internet—you know exactly who you're talking to in real-life. It gave me some interesting ideas. Some people in Platform were using their phones while talking—they weren't being rude—they were using the App—blogging what we were talking about. Other people were joining in online. One guy was connecting with someone in London England where another Platform was located-who was discussing the exact same thing. Then I ran into an old school friend who I hadn't seen in years. I spent a great evening out just talking to people. So much nicer when you do it in real-life in a real place as created by the Platform.

### User Experience 2 of a Possible Embodiment of the Platform

### Professional Business User—Expert Networking Forum on Novel Cancer Therapies.

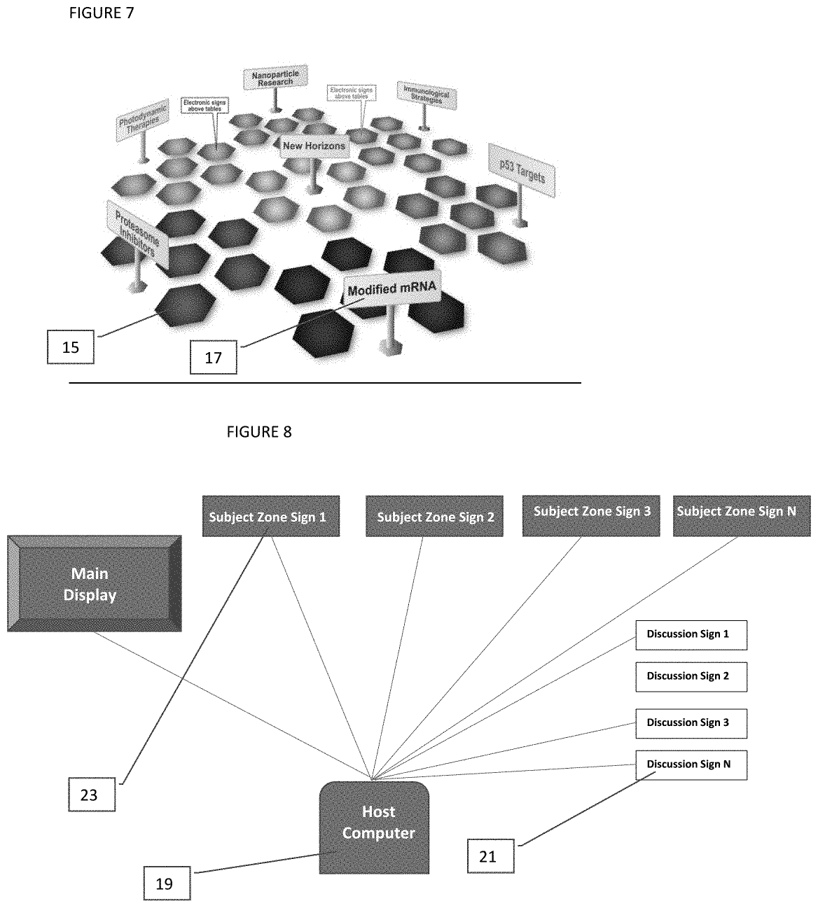

See FIG. 7 which shows another embodiment of the color-coded arrangement of spaced apart locations (15) and subject zone signs (17) for an expert networking event in medical science.

### Professional Business User Experience:

The conference was a big waste of time and money. I was just sitting there for hours—listening to stuff I knew already. So I decided to go to a networking event in the evening using the Platform. There, at one table, in the pink zone were the four people I most wanted to speak to in the world. All of them experts in my field of cancer immunotherapy. It was an important conversation—we confirmed our findings and the way forward. I also finally managed to contact the CEO of that Biotech company, who I'd been trying to catch up with for ages. It only happened because we set up another group in the New Horizons zone—to discuss the novel treatment strategy we'd been working on. Then he came to us straight away! We were blogging our discussion live online—others joined in from the conference—and worldwide. So we got wider recognition—which is important. I've been asked to do the keynote speech at the next conference in summertime—which I hate. But I'm really looking forward to another networking event afterwards that used the Platform.

### Technical Specification of One Embodiment

System Overview: A computer driven array of transparent electronic display screens.
1. The Display Screens above tables/seating are approx. 2.5 ft.×1.25 ft. light-weight and transparent—such as OLED. Cheaper transparent LCD can be used illuminated with coloured light. LCD projectors can be utilized to illuminate semi-mirrored glass (which is the most feasible option at this time).
2. The Aspect ratio of screens is at least 16:9 or preferably wider, i.e., 2:1.
3. The screens can display at least 50 text characters on two lines/20 characters on one line in at least 12 different colours.
4. 50 text characters displayed at max size are readable from 100 ft. in all background light levels.
5. The display screens are suspended from the ceiling using wires and power used for lighting. All connectors and ceiling fixtures are provided by the fabricator.
6. The system is modular in construction and can accommodate from 12-60 discussion signs at discussion locations.
7. A very large display unit at the entrance gives an overview and shows what's being displayed at every table as well as the colors of subject zones and the names of subject zones. The display unit should be at least 3 ft. by 5 ft. so that a group of people can view it at once—to gain an overview of all discussion topics and all subject zones. This display unit need not be transparent.

### Implementation

Customized software drives the displays as shown in this specification. The software that drives our platform will be a purpose-built digital signage system with exactly the functionality specified here. The digital content is simple text and graphics as described in this spec.

The system is preferably generic, i.e., any type of TV/Monitor Screen can be used. The system will be modular—any number of screens can be added in and shown on the main display.

Transparent Screens above tables can be OLED (when available), cheaper transparent LCD display (backlit) or partly mirrored Glass screens illuminated by LCD projector. Screens must look very good. Transparent OLED is still not yet widely commercially available at reasonable cost—transparent screens illuminated by LCD projector are currently the most cost efficient option.

The screens at any one installation can be driven by wifi from one computer with a wifi plug-in though standard HDMI, DVI or VGA inputs. Our platform could be implemented as a LAN/Intranet hardwired through an Ethernet connection. The system will have automatic plug and play when screens are connected. Installations can be hardwired particularly if developers believe that wifi is too unreliable.

The digital signage system that drives the Platform can be ‘web-based’ but it should also be implemented entirely locally as a LAN/Intranet. It should not have to rely on connection to any external third party website. Individual screens could for example be implemented as separated HTML webpages on an intranet (but not on an external website).

The system should have full functionality and should be very easy and intuitive to operate from a single host computer. The user-interface should be simple and intuitive. It should be very easy for the platform operator to set-up and change discussion signs on screens. It should be very easy to set up and change the names and colors of subject zones.

The user-interface should not require the operator to enter any additional information which is irrelevant to this specification. The operator should not be presented with any confusing menu choices or require any data to be inputted which is not part of this specification. The system should regularly archive and back-up all discussion signs and subject zones with dates and times.

Subject Zones

Large display units to name subject zones typically one subject zone sign for every 6-8 tables/discussion signs. The subject zone sign can be surrounded by 6-8 tables/signs as shown in the diagram. Subject Zone Signs are ideally 2 ft.×5 ft. displaying text at twice the size of discussion zone signs.

Light from LCD projectors which illuminate discussion signs, should also be used to illuminate tables in the color of the subject zone. Alternatively, the ceiling above a discussion location can be illuminated in the color of the subject zone, by the LCD projector. The discussion sign may also be reflected onto the table surface or the ceiling above a discussion location.

Tables for formal business networking
Tables are typically round and 3.5 ft. in diameter for 6 people.
Seating at tables is best fixed and low-level to avoid blocking access.
Optional: Center pieces in tables allow displays—such as fire or water or abstract images—as a focal point for discussion.
Optional: Advanced installations allow the rest of the table to be illuminated in the color of the subject zone.
Optional: Noise dampening technology can be placed at tables to create a ‘conversation bubble’.

Seating for Nightlife Venues
Informal seating should be provided instead of tables at nightlife venues.
Circular (ring shaped soft seating) can be placed below signs to create a campfire feel. Simulated fire-effects and visual displays can be put at the center.
Conversation pits can be created in purpose-built installations.

FIGS. 5A and 5B show examples of seating arrangements (7) and (9) for informal face-to-face discussions.

Space Requirements

The Platform is able to utilize spaces without natural lighting very effectively. The environment should be acoustically soft to reduce excessive noise. Soft furnishings and sound absorbent surfaces improve a location—noise cancelling technology can be used to create private ‘conversation bubbles’ in showcase installations.

An installation with 64 discussion locations, i.e., 8×8 rows of circular tables in a square configuration requires 3721 sq. ft. minimum to accommodate 384 people. That is a square of 61 ft×61 ft. Discussion locations must be acoustically soft.

This equates to 9.6 sq. ft. per person. This compares to 10 sq. ft. per person for restaurants—the space requirements for conversation are of course less than those required for dining. Each discussion location for 6 people requires 58 sq. ft., i.e., 7.6 ft×7.6 ft. Sound insulation will be required in densely packed spaces.

Architectures and Design Themes

Platform installations may be themed with natural features such plants, rocks, water features, beach scenes, images of sunsets. Creating purpose-built forums will be an exciting challenge for designers and architects.

The Software that Drives a Possible Embodiment of the Platform

Configuration to a Specific Customer Location
1. System recognizes screens from wifi plug-ins (or other hardwired connection), it allocates a number to each discussion sign/table which is represented by a circle on the large display screen (also on the controlling computer).
2. Tables (represented as circles) with discussion signs can be positioned on the large screen to reflect their position in the physical installation.
3. Boxes to name whole subject zones can be positioned on the display screen. These will correspond to the large subject zone signs.

Functionality
1. Colors and names of subject zones can be easily inputted and updated from the controlling computer by the operator.
2. Discussion topics are easily inputted by the operator on the host computer and displayed on the discussion signs (above tables) always in the color of the subject zone.
3. Discussion topics are displayed on the controlling PC and simultaneously on the large display that gives an overview of the location where the Platform is installed—always in the color of the subject zone.
4. Names of subject zones are also displayed on large subject zone signs covering a group of tables, i.e., covering several discussion signs and tables.
5. On the overview display—tables/seating are represented by circles and discussion subjects appear as rectangles inside the circles. Tables are only shown as hexagons in the artist's impression.
6. On the overview display—subject zones are shown inside large rectangles—associated with a group of tables all in the same color.
7. All the above can be easily updated and amended from the controlling PC.
8. Any number of discussion signs can be added to subject zones—always in the color of the subject zone.
9. Discussion signs remain transparent when not in use—even when other signs are activated.
8. The software must regularly archive and back-up all discussion signs and zones on the display.
9. On the night-setting, text on discussion signs appears very brightly on the transparent screen with transparent background, (text is in the color of the subject zone).
10. In the daylight-setting, the text appears in black (or in white) on a colored opaque background, which is always the color of the subject zone.
11. The user-interface should not require the operator to enter any additional information which is irrelevant to this specification.
12. The operator should not be presented with any confusing menu choices or require any irrelevant data to be inputted which is not part of this specification, that may have come from previous software which has been adapted.
13. The operator should not have to ‘hack into’ the software or enter meaningless bits of code and HTML. The user interface for the platform operator must be very easy and intuitive.
14. Software should be fully encrypted and locked requiring individual activation codes to prevent piracy.

Advanced Functionality
1. The software connects to a website for activation and monitoring.
2. Online users can log in to the website or use an App to see what is being discussed at each Platform installation.
3. Customer Business Registration
Customer name and address, hours and days of operation and activation codes are required
Monthly reactivation from our website on payment of license fees.

In connection with the features of the invention above, a software specification as one preferred embodiment of the invention is provided concerning the software and hardware aspects and specifications relating to the Platform, including a Hardware Overview, Configuration

### Hardware Overview of an Embodiment

FIG. 8 which illustrates typical hardware components of an embodiment of the communication system, host computer (19), discussion signs (21), subject zone signs (23).

### Software Specification of an Embodiment

Initialization Mode

| Inputs | Outputs & Device | Stored |
|---|---|---|
| Host Business Name | Host Business Name | Host Business Name |
| and Address | and Address dis- | and Address stored. |
| | played on host | |
| | computer | |
| Screen type: Main | Screen type and | Screen type, screen |
| display, subject zone/ | number displayed on | number, internal |
| number, discussion | host computer. | screen address, |
| sign/number. By manual | | connection pathway to |
| input or plug-and- | | send data to screen. |
| play. | | |
| User (or software) | Name/number of each | |
| prompts system to send | screen is displayed | |
| a test message to each | on each screen. | |
| screen. | | |
| User confirms that each | Host pc displays | Screen type, screen |
| screen and its drivers | function status of | number, internal |
| are working/not working. | each screen. Test | screen address, |
| | process is repeated | connection pathway, |
| | as required. | and function status. |
| User exits initialization | Transition to Config- | System test status. |
| mode when system test is | uration mode. | Initialization |
| fully confirmed. | | completed yes/no. |

### Initialization Mode

1. Input Host Business Name and Address (archive and store permanently)
2. System recognizes all screens (and drivers) when attached (manually or plug-and-play)
3. Software allocates an address to each display screen, this can be a ‘web page address’ for each screen, if the system is web-based, i.e., implemented as an Intranet (but not via the Internet)
4. The ‘Main Display Screen’ is given a unique address. (and stored)
5. ‘Subject Zone’ signs are given a unique address (subject zone 1, Subject zone 2 . . . etc. up to 12 subject zone signs).
6. ‘Discussion Signs’ are given a unique number as an address, simply 1, 2, 3 . . . to 60.
7. Names and addresses of all display screens are stored permanently.
8. A test message is sent to each screen, so it displays its own name/address.
9. After system tests and user confirmation, system exits initialization and enters configuration mode.

Configuration Mode

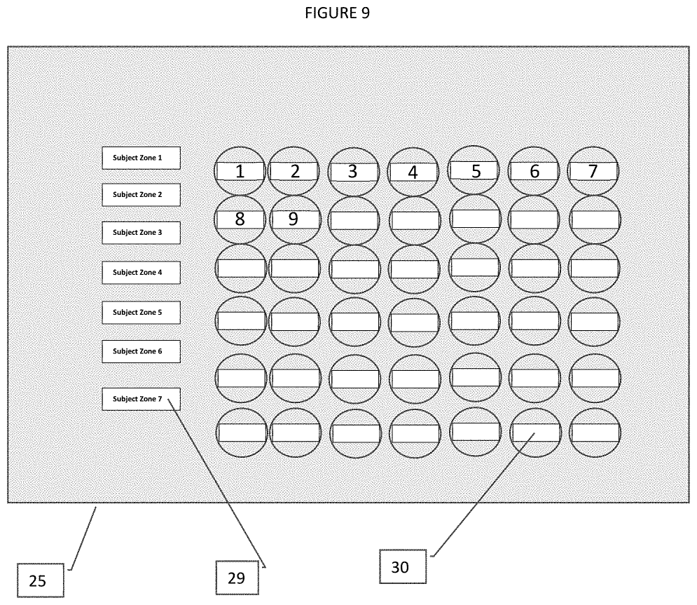

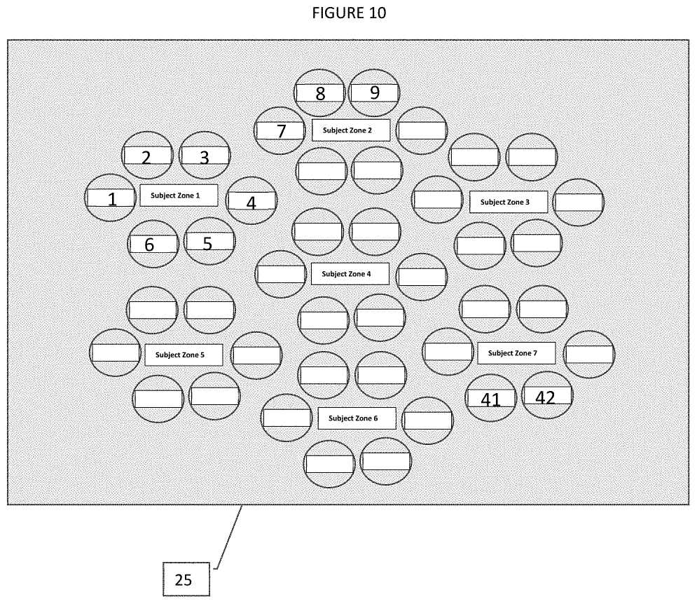

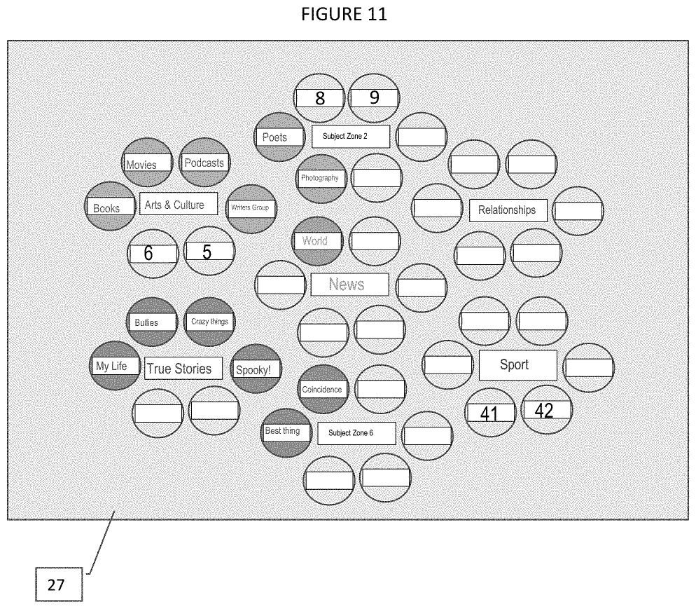

Configuration to the host site—matching screens to their physical location. FIG. 9 shows a pre-configuration and FIG. 10 shows post-configuration. Note all displays and graphics should be ultra-high quality.
1. Each Subject Zone sign is represented by a white rectangle on the Main Display screen and also on the host computer. Subject Zones are numbered as shown.
2. Each Subject Zone sign can be dragged to a position that matches its location in the physical installation.
3. Each discussion sign is represented by a circle with a white rectangle inside. All discussion signs are numbered as shown.
4. Each discussion sign can be dragged to a position that matches its location in the physical installation.
5. The site configuration is permanently stored and archived.

Configuration Mode

| Inputs | Outputs & Device | Stored |
|---|---|---|
| Final position of | All subject zone | Final position of all |
| each subject zone | signs displayed in | subject zone signs on |
| sign. User drags by | final positions on | Main Display is stored. |
| mouse on host | Main Display and on | (Together with sign |
| computer. | Host Computer | number, address etc.). |
| Final position of | All discussion signs | Final position of all |
| each discussion sign. | displayed in final | discussion signs is |
| User drags by mouse | positions on Main | stored. (Together with |
| on host computer. | Display and on Host | sign number and address |
| | Computer. | etc.). |

FIG. 9 shows the main display (25) or host computer display of the communications system with objects representing subject zone signs (29) and discussion signs (30), before configuration to a site.

FIG. 10 shows the main display (25) or host computer display of FIG. 8 after configuration to a site.

Operational Mode

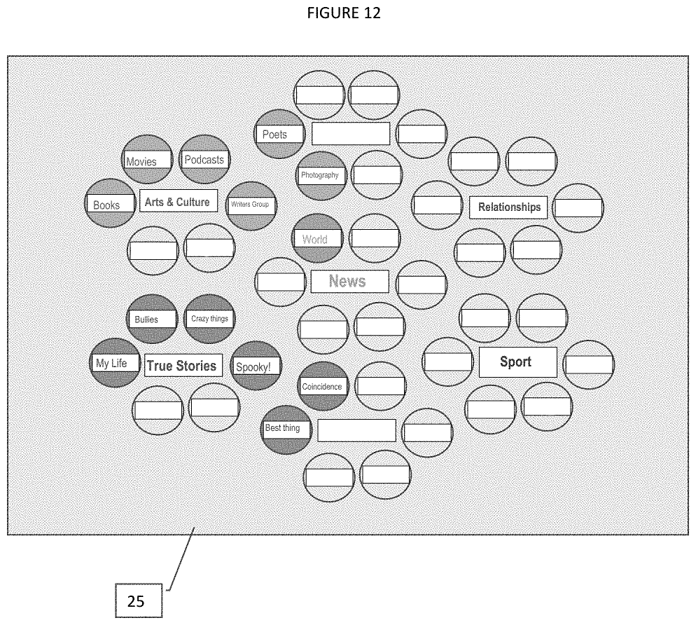

FIG. 11 shows the configuration of FIG. 10 on the host computer display (27) in operational mode.

FIG. 12 shows the main display (25) in operational mode.

After initialization and configuration, the system boots up in Operational Mode only. Initialization and configuration modes are locked away and are not normally accessed unless the system needs to be updated.

In Operational Mode—Discussion Signs and Subject Zone signs are all controlled from the host computer and are also shown on the Main Display. Each subject zone sign and discussion sign is selected by clicking on it—on the host computer. The text to be displayed on the signs is entered—together with the color of the text. Text size is scaled on all signs to be as large as possible—the default is for one line or two lines if needed. Text should be heavy bold to maximize visibility.

In FIGS. 11 and 12, subject zones 2 and 6 are not used. The host computer shows the number of all unused signs including 2 and 6—but the main display does not show them. Similarly, the Host Computer shows all unused discussion sign numbers such as 5, 6, 8 and 9—but the Main Display does not show them.

All signs are kept off when not used so that clear OLED is transparent and ordinary screens are black when they are not being used.

Discussion signs and subject zone signs can display in both day and night settings. With night-setting the signs show the text in the color of the subject zone—with the background of the screen turned off. This means that the background will be transparent for clear OLED, and black background for a normal screen on night-setting.

In day-settings the background of the sign is in the color of the subject zone. The text is in bright white (or in black) if that provides better contrast.

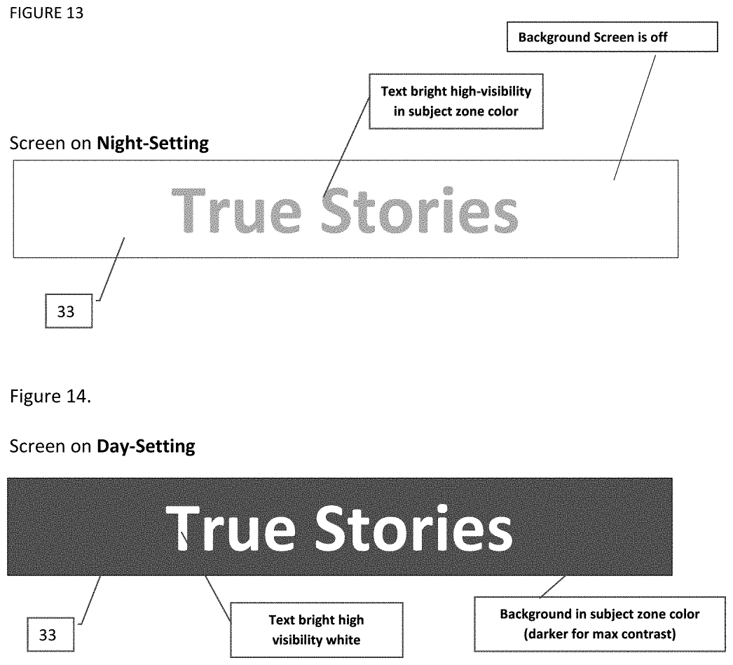

FIG. 13 which shows a night setting configuration for a discussion sign (33) and FIG. 14 which shows a day setting configuration for the same discussion sign (33).

Operational Mode
1. Once configured, the system boots up in Operational Mode.
2. The user enters their name, the name of the event, the date and the time.
3. The user selects day-setting or night-setting. These can be changed while an event is in progress.
4. The Host Computer display shows the platform fully configured as per FIG. 10, with all discussion signs and subject zone signs numbered.
5. The Main Display shows the platform fully configured similar to FIG. 10, but all discussion signs and subject zones are blank (white).
6. The user selects a subject zone sign by clicking on it, on the host computer. The user enters the names of each subject zone as text and selects its color from a menu of at least 20 colors. Text is displayed on the subject zone sign itself at maximum size, using one or two lines of text as needed. It is displayed on the subject zone sign in the color chosen by the user. It is displayed on the subject zone sign in day or night-setting as selected. (see FIGS. 13 and 14)
7. The subject zone (text) is also displayed on the Main Display and on the host computer as shown in FIGS. 11 and 12, in the color selected.
8. The user selects a discussion sign by clicking on it on the host computer. The user enters the discussion subject as text and selects a color from a menu consisting only of the colors chosen for subject zones. Text is displayed on the discussion sign at maximum size, using one or two lines of text as needed. It's displayed on the sign in the color chosen (which is the same as the subject zone it is in). Text is displayed on discussion sign in day or night-setting as selected.
9. The discussion sign (text) is also displayed on the Main Display and on the host computer as shown in FIGS. 11 and 12, in the color selected. The circle surrounding each discussion sign is filled in the color of the subject zone selected as shown in FIGS. 11 and 12.
10. Subject zone signs and discussion signs which are not used remain off.
11. Subject zone signs can be amended and updated, by clicking on them on the host computer, adding new text/selecting a new color.
12. Discussion Signs can be amended and updated, by clicking on them on the host computer, adding new text/selecting a new color.
13. The system regularly archives everything that is being displayed on all signs.
14. Archived data can be selected (by date and time) and displayed on the platform.
15. All discussion signs and subject zone signs can be cleared/reset so that new subjects can be displayed.

Operational Mode

| Inputs | Outputs & Device | Stored |
|---|---|---|
| User inputs their | Displayed on host | Stores name, name |
| name, name of the | computer | of the event, (date |
| event, (date and | | and time can be |
| time can be input | | input from internal |
| from internal clock) | | clock) |
| User selects day- | Determines display | |
| setting or night- | mode for subject- | |
| setting. | zone signs and | |
| | discussion signs as | |
| | per FIGS. 13, 14. | |
| User selects subject | Text displayed on | |
| zone sign by mouse | subject zone sign in | |
| click on host computer | chosen color, in day- | |
| (diagram 3). Selects | setting or night | |
| color, and enters text | setting as selected, | |
| for subject zone. | as shown in FIGS. | |
| | 13, 14. Displayed on | |
| | host computer (as FIG. | |
| | 11) and Main Display | |
| | (FIG. 12). | |
| User selects discussion | Text displayed on | |
| sign by mouse click on | Discussion Sign in | |
| host computer (diagram | chosen color, in | |
| 3). User selects color - | day-setting or night | |
| which can only be | setting as selected, | |
| selected from colors | as shown in FIGS. 13 | |
| used for subject zones. | and 14 Displayed on | |
| User enters text for | host computer (as | |
| subject zone. | FIG. 11) and Main | |
| | Display (as FIG. 12). | |
| User selects archive all | | Archived under date |
| data. | | and time - all data |
| | | and graphics asso- |
| | | ciated with the |
| | | host computer view |
| | | (FIG. 11). |
| User selects clear all | All subject zone and | |
| data. | discussion signs are | |
| | off and associated data | |
| | is cleared from the host | |
| | computer and the main | |
| | display. | |

### Additional Requirements

1. Branding for the Platform and the city/location of the installation to appear on the main display.
2. Individualized Password 1 to activate the software (set by administrator of Platform).
3. User set Password 2 for operational mode.
4. Password 1 to re-enter initialization/configuration modes.

I claim:

1. A communications system, said communications system comprising:
an array of spaced apart locations at each of which a plurality of users may enter into discussion with one another in person,
discussion signs for displaying subjects for discussion, wherein each discussion sign is associated with a location, whereby the discussion signs are able to display subjects for discussion at the location associated with each location,
subject zone signs, each subject zone sign associated with a number of spaced apart locations and configured for displaying a subject that is common to the discussions at the spaced apart locations,
a main display that provides an overview that shows a physical location of the subject zone signs and discussion signs associated with a subject zone sign,
control means for operating at least said discussion signs so as to enable said discussion signs to display subjects for discussion wherein said control means can amend the information displayed by said discussion signs so as to enable said discussion signs to display new subjects for discussion, and
progression indicia associated with either a discussion sign, a subject zone sign, or one of the locations, the progression indicia indicating that a subject and/or a common subject is moving from one location to another so one or more users can migrate to a different location for discussion.

2. The system of claim 1, wherein the progression indicia is displayed on a subject zone sign or discussion sign or other structure positioned between the location and the different location.

3. The system of claim 2, wherein the progression indicia includes an arrow or other directional signal, illuminated or non-illuminated, and/or the other structure includes a walking surface between locations or an elevated surface, preferably a ceiling between locations.

4. The system of claim 1, wherein the control means is configured to track one or more users' movements between locations using a mobile device of the user and a link between the mobile device and the control means.

5. The system of claim 1, wherein the control means is configured to track the change of location of subjects and common subjects.

6. The system of claim 1, wherein the progression indicia displays changes that have occurred for subjects or common subjects so that a user can see how the subjects or common subjects have mutated.

7. A communications system, said communications system comprising:
an array of spaced apart locations at each of which a plurality of users may enter into discussion with one another in person,
discussion signs for displaying subjects for discussion, wherein each discussion sign is associated with a location, whereby the discussion signs are able to display subjects for discussion at the location associated with each location,
subject zone signs, each subject zone sign associated with a number of spaced apart locations and configured for displaying a subject that is common to the discussions at the spaced apart locations,
a main display that provides an overview that shows a physical location of the subject zone signs and discussion signs associated with a subject zone sign,
control means for operating at least said discussion signs so as to enable said discussion signs to display subjects for discussion wherein said control means can amend the information displayed by said discussion signs so as to enable said discussion signs to display new subjects for discussion, and
wherein each location defines a subject zone and a set of spaced apart locations define a discussion location, and
a plurality of pathways positioned between adjacent subject zones and adjacent discussion locations, the plurality of pathways having indicia at pathway junctions, the indicia displaying information about at least one of subject zone locations and discussion locations to allow users to choose different pathways based on a user's desire to participate in discussion of a particular subject at a subject zone location or move to a different discussion location for consideration of participation in discussion for a particular subject.

8. The system of claim 7, wherein the indicia is either physical indicia for any user to see or the indicia is displayed on a user's mobile device using the control means so that only the user of the mobile device can see information about the subject zone locations or discussion locations.

9. The system of claim 7, wherein the pathways are sized to allow face-to face discussions between users moving along the pathways or include face-to face discussion locations larger than the pathway and between locations to allow users to participate in discussions before reaching another location, and optionally the face-to face discussion locations are provided to one or more users through a user's mobile device.

10. The system of claim 7, wherein users are provided with mapping information to the available discussion locations and subject zones through a mobile device to allow a user to select and/or follow a pathway direction for a desired discussion location or subject zone based on the mapping information.

11. The system of claim 8, wherein a user profile is registered with the system using the control means and the control means can group users together on a pathway using profiles of the users when a user seeks other discussion locations or subject zone locations through the user's mobile device.

12. A method of communication to facilitate face-to-face discussion, said method comprising:
(i) providing an array of spaced apart locations at each of which a plurality of users may enter into discussion with one another,
(ii) providing each location with indicia associated with a subject for discussion,
(iii) displaying discussion topics by said indicia at said spaced apart locations, enabling users to gather together at said spaced apart locations to form groups to pursue the discussion indicated by said indicia,
(iv) displaying a new discussion topic by at least one of said indicia at said spaced apart locations to set up a new discussion group,
(v) providing either a remote control or a local control to alter said indicia at at least one of said spaced apart locations to display new discussion topics to set up a new discussion group at said location, and controlling said indicia at at least one of said spaced apart locations by said remote or local control whereby users may participate in person in a structured networked discussion; the method further comprising including one or more of the following steps:
a) the spaced apart locations are located in a business or organization and an entry fee is charged to each of the plurality of users;
b) the spaced apart locations are located in a business or organization and an owner of the business is charged a fee to practice steps (i-v);
c) one or more product or service advertisements or sponsorships are displayed along with discussion topics or displayed subjects associated with the discussion topics and fees are charged for display of the product or service advertisement or sponsorships;
d) fees are charged for each spaced apart location or fees are charged for a plurality of spaced apart locations and, optionally, fees vary based on topics of discussion;
e) one or more of the following activities, events, or uses takes place at the spaced apart locations:
events for the provision of financial services;
creating focus groups, and optionally creating focus groups for market research or for product development or for political organizations;
political events;
cultural events;
conventions;
book fairs;
trade shows;
community events;
civic events;
personal development events;
professional development events;
improving communication within companies or organizations;
improving communication between companies or between organizations;
group therapy or other therapeutic use based on face-to-face conversation;
providing social interaction for medical or therapeutic use;
providing social connection for medical or therapeutic use;
connection patient groups with related medical conditions for medical or therapeutic use;
sharing experiences of medical conditions for medical or therapeutic use;
teaching or learning communication, networking, or social skills for educational use;
teaching and learning using face-to face networking for educational use;
recruitment events, and optionally matching job applicants to employers;
mediation events; including group or individual mediation;
conflict resolution events; and
dating events;
f) creating a database of users who have participated in one or more structured networked discussions and charging a fee to a user to access the database, or offering a membership to a user for future access to structured networked discussions in one or more locations;
g) the spaced apart locations are located in a business which provides networking events using steps (i-v) to attract customers to that business to increase revenue;
h) a business or organization is charged a fee to host or to sponsor an event at the spaced apart locations using steps (i-v) or at a plurality of the spaced apart locations using steps (i-v);
i) a licensing fee is charged for use of the spaced apart locations by a business other than the business or organization in which the spaced-apart locations are located.

13. The method of claim 12, wherein the business or organization is one of a nightlife business, a food and/or drink serving establishment, a retail merchant, a shopping mall, a dating service, a convention center, a conference or trade show organizer, a financial services provider, a marketing company, a public relations company, an events company, an events organizer, an entertainment company, a networking company, a social networking company, a business networking company, or a social media company, a university, an educational organization, or a training provider, a professional association, a personal development organization/business, a professional development organization/business, a business that provides audio visual services, a business that builds displays for conferences, conventions or for events, a business that provides technology or technical services for conferences, conventions or for events.

14. The method of claim 12, further comprising:
a networking event, and optionally wherein the networking event includes one of business networking, social networking, professional career networking, expert networking, and expert networking in areas including medicine and related professions, science, biotechnology, pharmaceuticals, technology, engineering, computing, electronics, digital technology, or
advertising or promotional or sales events; or advertising or promotional or sales events that involve face-to-face networking, or
dating events involving face-to-face networking; or
dating events involving matching individuals to each other, or dating events involving matching individuals who share interests a combination thereof, and
one or more combinations thereof.

15. A communications system, said communications system comprising:
an array of spaced apart locations at each of which a plurality of users may enter into discussion with one another in person,
discussion signs for displaying subjects for discussion, wherein each discussion sign is associated with a location, whereby the discussion signs are able to display subjects for discussion at the location associated with each location,
optionally subject zone signs, each subject zone sign associated with a number of spaced apart locations and configured for displaying a subject that is common to the discussions at the spaced apart locations,
a main display that provides an overview that shows a physical location of the subject zone signs and a discussion signs associated with a subject zone sign,
control means for operating at least said discussion signs so as to enable said discussion signs to display subjects for discussion wherein said control means can amend the information displayed by said discussion signs so as to enable said discussion signs to display new subjects for discussion, and one or more of the following features:
i) a plug and play feature, wherein a variable number of discussion signs and/or subject zone signs may be connected to the control means, wherein discussion signs and/or subject zone signs are assigned a unique address by the control means and stored therein, enabling data to be sent uniquely to each discussion sign and/or to each subject zone sign by the control means, and
optionally the control means sends a test signal after connection to each discussion sign, to the main display, and to subject zone signs to check that each are functioning correctly, and
ii) an image is created on the main display corresponding to each discussion sign and/or to each subject zone sign, wherein the image corresponding to each discussion sign and to each subject zone sign is able to display the same information as the corresponding discussion sign and subject zone sign, and
iii) a unique identifier is displayed on each discussion sign and/or on each subject zone sign wherein the same identifier is associated with the image created on the main display (or on the control means) corresponding to each discussion sign and/or each subject zone sign to allow each discussion sign and/or each subject zone sign to be matched to its corresponding image on the main display (or on the control means),
iv) a configuration feature, wherein each discussion sign/and or subject zone sign is represented by a corresponding graphic on the main display (or on the control means), wherein each graphic may be dragged on-screen to a position corresponding to the position of the corresponding discussion sign/subject zone sign within the array of spaced apart locations, the display of the subject zone optionally having a different configuration than the display of the discussion topic sign,
v) a feature, wherein a user is able to allocate a discussion subject to a subject zone and the communication system displays discussion subjects in the same subject zone in the same color, and/or the system selects adjacent discussion signs to display discussion subjects that are in the same subject zone, and/or the system selects different colors for adjacent subject zones, and
vi) the communications system provides a data interface to the Internet, enabling online users to see discussion subjects displayed on discussion signs and/or enabling discussion signs to be controlled remotely through the Internet,
vii) the discussion topic is displayed with a day or night setting; and
viii) one or more of the subject signs and discussion topic sign associated therewith can be turned off during the event; and
ix) one or both of each subject sign and discussion topic sign can be amended during the event with different subjects or different topics or colors; and
x) the communication system archives information displayed on discussion signs and/or subject zone signs and/or wherein the system is able to display some or all of that archived information at a later time.

16. The system of claim 15, wherein each of the (i-iv) are included in the system.

17. The system of claim 15, wherein each of (i)-(v) are included in the system.

18. The system of claim 15, wherein one of (i-vi), (i-vii) (i-vii), (i-viii), (i-ix), (i-x) are included in the system.

19. A communications system said communications system further comprising one or more platforms, each platform having the following:
an array of spaced apart locations at each of which a plurality of users may enter into discussion with one another in person,
discussion signs for displaying subjects for discussion, wherein each discussion sign is associated with a location, whereby the discussion signs are able to display subjects for discussion at the location associated with each location,
optionally subject zones signs, each subject zone sign associated with a number of spaced apart locations and configured for displaying a subject that is common to the discussions at the spaced apart locations,
a main display that provides an overview that shows a physical location of the subject zone signs and a discussion signs associated with a subject zone sign,
control means for operating at least said discussion signs so as to enable said discussion signs to display subjects for discussion, and one or more of the following:
a) a data interface between the at least one platform and one or both of a website and an app, the data interface enabling one or more users of the platform to:
i) find out what's being discussed face-to-face at the one or more platforms, the users being online or physically present at the one or more platforms when using the data interface;
ii) vote to create a new face-to-face discussion group; creation of new face-to-face discussion groups done remotely online before the one or more users arrive at the one or more platforms or the one or more users are physically present at the one or more platforms;
iii) register to join a discussion group while at the one or more platforms or remotely online;
iv) create a new discussion group while physically present at the one or more platforms or remotely online;
b) a data interface between each of the one or more platforms and one or both of a website and an app, the data interface enabling a plurality of users present at the one or more platforms or online:
(i) to propose ideas for new subject zones and new discussion group topics;
ii) to vote on proposed new discussion group topics;
iii) to vote for the most popular discussion topics to be chosen for face-to-face discussion at locations;
iv) to vote on ideas discussed in face-to-face discussion groups;
c) one of both of an App or website linked to the one or more platforms, the app or website capable of one or more of the following features:
i) enabling popular and trending face-to-face discussion topics to be identified and displayed at platforms in different geographic locations;
ii) enabling users to communicate online if the users are discussing the same subject (or related subjects) in platforms in different geographic locations;
iii) enabling users to communicate online, if they are discussing the same subject or similar subjects in different groups in the same platform;
iv) enabling users to have online discussions, which are related to the face-to-face discussions occurring in the one or more platforms; those users may be online or physically present in the one or more platforms;
v) enabling users physically present in the one or more platforms to have face-to-face discussions, which are related to discussions occurring online;
vi) enabling face-to face discussion locations and discussion signs at locations to only be identified by user smartphones/mobile devices;
vii) enabling face-to face discussion locations and discussion signs at locations to be identified by user's smartphones by placing bar-codes or similar optical recognition indicia at physical locations; and
viii) enabling users to text-message discussions, as well as audio and video discussions, which are related to the face-to-face discussions occurring in the one or more platforms; wherein users may or may not be physically present in the one or more platforms.

20. The system of claim 19, wherein users with computers, smartphones or mobile devices connect with each other and/or with the one or more platforms through wifi or bluetooth or other known telecommunication means, to achieve any of the functionality described in a(i-iv), b(i-iv), and c(i-viii).

21. A communications system, said communications system comprising:
an array of spaced apart locations at each of which a plurality of users may enter into discussion with one another in person,
discussion signs for displaying subjects for discussion, wherein each discussion sign is associated with a location, whereby the discussion signs are able to display subjects for discussion at the location associated with each location,
optionally subject zone signs, each subject zone sign associated with a number of spaced apart locations and configured for displaying a subject that is common to the discussions at the spaced apart locations,
a main display that provides an overview that shows a physical location of the subject zone signs and discussion signs associated with a subject zone sign, control means for operating at least said discussion signs so as to enable said discussion signs to display subjects for discussion wherein said control means can amend the information displayed by said discussion signs so as to enable said discussion signs to display new subjects for discussion,
one or more of the discussion signs further comprising:
a) transparent discussion sign so that the discussion topic appears written in the air at or near a discussion location, and optionally either, the transparent discussion sign is created by optical projection onto a semi-mirrored transparent surface, or the transparent discussion sign is created using OLED or QLED, or the transparent discussion sign has a day and night setting, wherein, in the night setting, for example at lower background light levels, text of the sign appears on a transparent background and wherein in the day setting, the text appears against a contrasting colored background for improved visibility;
b) indicia on the one or more discussion signs creatable by a smart phone or mobile device, and optionally including one or more of the following features:
i) the one or more discussion signs can be associated with a discussion location by mobile devices including smart phones;
ii) the one or more discussion signs can be associated with a discussion location by mobile devices using GPS technology and other location services;
iii) the one or more discussion signs can be associated with a discussion location by mobile devices together with other mobile devices at a physical location;
iv) the one or more discussion signs can be associated with a discussion location, by smart phones together with other smart phones at the same physical location;
v) a discussion topic displayed on the one or more discussion signs can be associated with a location using a mobile device and either bluetooth or wifi;
vi) discussion sign locations and face to face discussion locations are identifiable only by one or both of a smartphone or mobile device; and
vii) discussion sign locations and face to face discussion locations are identifiable only by one or both of a smartphone or mobile device via bar codes or other optical recognition indicia at physical locations; and
c) the one or more discussion signs are associated with an image or visual effect and optionally one or more of the following features:
i) the image is still or moving, optionally the image is fire or water;
ii) the image is still or moving, optionally the image is fire or water, and the discussion sign is projected within the image and the discussion sign text appears within the image as an area of greater brightness, darkness or in contrasting colors;
iii) the discussion sign is projected into smoke, fire, mist, steam or vapor at discussion locations or into any medium containing particles capable of creating an image through the Tyndall effect;
d) the one or more discussion signs are associated with an actual fire or a fire effect and optionally the discussion signs form part of the actual fire or fire effect, or the discussion topic appears within the fire or fire effect, as an area of greater brightness, darkness or in contrasting colors.
